(19) United States
(12) Patent Application Publication
(10) Pub. No.: US 2015/0025962 A1
(43) Pub. Date: Jan. 22, 2015

(54) SYSTEM, METHOD, AND COMPUTER PROGRAM FOR PRICING AND ALLOCATING ADVERTISING INVENTORY ON DIGITAL AND WEB PUBLISHER PROPERTIES

(71) Applicants: Sean Anderson BECKET, Brooklyn, NY (US); Andrew Logan BECKET, Nashville, TN (US)

(72) Inventors: Sean Anderson BECKET, Brooklyn, NY (US); Andrew Logan BECKET, Nashville, TN (US)

(21) Appl. No.: 14/320,922

(22) Filed: Jul. 1, 2014

Related U.S. Application Data
(60) Provisional application No. 61/847,699, filed on Jul. 18, 2013.

(51) Int. Cl. G06Q 30/02

(52) U.S. Cl. CPC G06Q 30/0277; G06Q 30/0249; G06Q 30/0272
USPC 705/14.48; 705/14.73; 705/14.68

(57) ABSTRACT

An apparatus and method that pulls campaign criteria from a plurality of servers, including a publisher's ad server, and processes user-input campaign criteria to generate a media plan wherein delivery goals and rates for each ad placement, and flight dates for fixed ad placements are determined by the system. While the delivery goals and the rates for each ad placement and the date for fixed ad placements are automated, there is a graphical user interface wherein a user can edit these values to meet the advertiser's specific needs. This media plan can then be sent to the advertiser via the system and pushed to the publisher's ad server as an order capable of receiving creative assets for ad trafficking.

### CROSS-REFERENCE TO RELATED APPLICATIONS

This application claims benefit of priority to U.S. Provisional Patent Application No. 61/847,699 filed Jul. 18, 2013, entitled “SYSTEM, METHOD, AND COMPUTER PROGRAM FOR PRICING AND ALLOCATING ADVERTISING INVENTORY ON DIGITAL AND WEB PUBLISHER PROPERTIES,” which is incorporated by reference in its entirety.

### BACKGROUND

1. Field of the Invention

The present invention relates to online advertising.

2. Related Art

There are various difficulties with the current processes by which digital and web publishers organize and sell the advertising space on their websites and applications.

### SUMMARY

According to a first broad aspect, the present invention provides an apparatus comprising: one or more processors, and a machine-readable medium for storing instructions thereon which when executed by the one or more processors cause the one or more processors to perform a method comprising the following steps: (a) assigning an optimal inventory allocation to each ad placement of one or more proposed ad placements, and (b) displaying the optimal inventory allocation of each ad placement on a visual display device to a user and/or saving the optimal inventory allocation of each ad placement to a storage medium, wherein the optimal inventory allocation of each ad placement is based on an available inventory for the ad placement, and wherein the inventory is a delivery metric inventory.

According to a second broad aspect, the present invention provides an apparatus comprising: one or more processors, and a machine-readable medium for storing instructions thereon which when executed by the one or more processors cause the one or more processors to perform a method comprising the following steps: (a) assigning an optimal rate to one or more ad placements, and (b) displaying the optimal rate on a visual display device to a user and/or saving the optimal rate to a storage medium, wherein the optimal rate is based on an available inventory for the ad placement, a rate card price floor for the ad placement, a rate card price ceiling for the ad placement and a historical rate for the ad placement.

According to a third broad aspect, the present invention provides an apparatus comprising: one or more processors, and a machine-readable medium for storing instructions thereon which when executed by the one or more processors cause the one or more processors to perform a method comprising the following steps: (a) assigning one or more flight dates to one or more respective fixed ad placements, and (b) displaying the one or more flight dates on a visual display device to a user and/or saving the one or more flight dates to a storage medium, wherein each of the one or more flight dates is assigned to a respective fixed ad placement based on an availability of dates within a campaign flight.

According to a fourth broad aspect, the present invention provides an apparatus comprising: one or more processors, and a machine-readable medium for storing instructions thereon which when executed by the one or more processors cause the one or more processors to perform a method comprising the following steps: (a) sending an adjusted inventory reservation to an ad server, and (b) displaying the adjusted inventory reservation on a visual display device to a user and/or saving the adjusted inventory reservation to a storage medium, wherein the adjusted inventory reservation is based on a sell-through probability for an ad placement and a delivery goal for the ad placement.

According to a fifth broad aspect, the present invention provides an apparatus comprising: one or more processors, and a machine-readable medium for storing instructions thereon which when executed by the one or more processors cause the one or more processors to perform a method comprising the following steps: (a) replicating fixed ad placements until a fixed placement minimum is met, and (b) displaying the replicated fixed ad placements on a visual display device to a user and/or saving the replicated fixed ad placements to a storage medium, wherein the fixed placement minimum is based on a cost of fixed ad placements in a target group.

### BRIEF DESCRIPTION OF THE DRAWINGS

The accompanying drawings, which are incorporated herein and constitute part of this specification, illustrate exemplary embodiments of the invention, and, together with the general description given above and the detailed description given below, serve to explain the features of the invention.

FIG. 1 is a diagram illustrating a process for a general exchange of information stemming from a system according to one embodiment of the present invention.

FIG. 2 shows a flowchart of a method according to one embodiment of the present invention of generating a media plan through an optimal inventory allocation based on campaign criteria entered by a user.

FIG. 3 shows a flowchart of a method according to one embodiment of the present invention of assigning optimal rates to ad placements based on campaign criteria entered by a user.

FIG. 4 shows a flowchart of a method according to one embodiment of the present invention of assigning flight dates to fixed ad placements based on campaign criteria entered by a user.

FIG. 5 shows a flowchart of a method according to one embodiment of the present invention of an adjusted inventory reservation pushed to an ad server based on campaign criteria entered by a user.

FIG. 6 shows a flowchart of a method according to one embodiment of the present invention of replicating fixed ad placements on a media plan based on settings created by an administrator and campaign criteria entered by a user.

FIG. 7 shows a screenshot of a homepage screen of a graphical user interface according to one embodiment of the present invention.

FIG. 8 shows a screenshot showing a Proposal window that opens when a user, such as a publisher, selects a New Proposal button on the homepage screen of FIG. 7 to create a new proposal.

FIG. 9 shows a screenshot of an Account window that opens when a user selects an Account button in the Proposal window of FIG. 8.

FIG. 10 shows a screenshot of a Budget window that opens when a user selects a Budget button in the Proposal window of FIG. 8.

FIG. 11 shows a screenshot showing a user dividing a budget into “target groups” by selecting an icon on the upper right of the Budget window of FIG. 10.

FIG. 12 shows a screenshot of a Flight window that opens when a user selects a Flight button in the Proposal window of FIG. 8. There are often multiple flights in a campaign. Even if it is one continuous flight, advertisers often ask for monthly delivery goals to accommodate their billing cycle. Therefore a campaign may distinguish a February flight, March flight, and April flight, even if it runs continuously from February 1-April 30.

FIG. 13 shows a partial screenshot of a Media window that opens when a user selects a Media button in the Proposal window of FIG. 8.

FIG. 14 shows a partial screenshot of the Media window of FIG. 13 in which a user has begun to select creative sizes.

FIG. 15 shows a partial screenshot of the Media window of FIG. 13 in which a user has brought selected sizes into a line item window by selecting a solid ring icon, which indicates a fixed ad placement.

FIG. 16 shows a partial screenshot of the Media window of FIG. 13 in which a user has added a rotational ad placement.

FIG. 17 shows a partial screenshot of the Media window of FIG. 13 in which a user selects ad placements and applies applicable settings.

FIG. 18 shows a partial screenshot of the Media window of FIG. 13 in which icons appear next to ad placements to indicate the setting has been applied.

FIG. 19 shows a partial screenshot of the Media window of FIG. 13 in which a user has assigned locations to selected ad placements.

FIG. 20 shows a partial screenshot of the Media window of FIG. 19 in which pin icons have become highlighted to indicate that respective locations have each been applied to the ad placement.

FIG. 21 shows a partial screenshot of the Media window of FIG. 20 showing that when all desired ad placements have been added, the user can copy them to other flights, budgets, and target groups as desired in a pop-up window.

FIG. 22 shows a screenshot of a probability window in which a user assigns a sell-through probability to a campaign and to each respective budget option.

FIGS. 23 and 23-1 show a screenshot of a media plan consisting of: ad placements entered by a user, and each ad placement's corresponding flight dates, rate, cost, and contracted inventory (impressions), which are automated by a system according to one embodiment of the present invention.

### DETAILED DESCRIPTION OF THE PREFERRED EMBODIMENTS

### Definitions

Where the definition of terms departs from the commonly used meaning of the term, applicant intends to utilize the definitions provided below, unless specifically indicated.

For purposes of the present invention, it should be noted that the singular forms, “a,” “an” and “the,” include reference to the plural unless the context as herein presented clearly indicates otherwise.

For purposes of the present invention, directional terms such as “top,” “bottom,” “upper,” “lower,” “above,” “below,” “left,” “right,” “horizontal,” “vertical,” “up,” “down,” etc., are used merely for convenience in describing the various embodiments of the present invention. The embodiments of the present invention may be oriented in various ways. For example, the diagrams, apparatuses, etc., shown in the drawing figures may be flipped over, rotated by 90° in any direction, reversed, etc.

For purposes of the present invention, a value or property is “based” on a particular value, property, the satisfaction of a condition or other factor if that value is derived by performing a mathematical calculation or logical operation using that value, property or other factor.

For purposes of the present invention, the term “ad campaign” refers to a coordinated effort to communicate an advertising message to a target audience of consumers and potential consumers. The advertiser enters an agreement with the publisher who provides a medium on which to display that message. It should be understood that the term “ad campaign” can have different meanings depending on whether it's from the perspective of the advertiser or the publisher. The advertiser has the perspective of a larger campaign, which may use multiple publishers to communicate the advertising message. The publisher, however, understands the ad campaign within the scope of the advertising displayed on the publisher's own properties. Any references to the term “ad campaign” herein should be understood as that from the perspective of the publisher unless stated otherwise.

For the purposes of the present invention, the term “ad creative” and the term “creative” refers to the message an advertisement is trying to convey, which may come in the form of artwork, text, video, etc.

For the purposes of the present invention, the term “ad creative assets” and the term “creative assets” refers to the physical medium that embodies the ad creative, which may come in the form of a .jpeg file, .gif file, .swf file, .mov file, .mp4 file, HTML, etc.

For purposes of the present invention, the term “ad impression” and the term “impression” refer to the display of an advertisement on a digital medium, recorded as a unique event by an ad server. An ad server will typically record an impression for each ad unit on each page view. The terms “deliver,” “serve,” or “display” can be used interchangeably to describe the impression response from the ad server to the webpage or other digital medium. An ad impression is a common form of delivery metric inventory.

For purposes of the present invention, the term “adjusted inventory reservation” refers to the process by which the system reserves inventory in an ad server with consideration to the sell-through probability of a given ad campaign and the ad placements within that ad campaign. Rather than reserving the full amount of proposed inventory, the system reserves an adjusted amount of inventory in the ad server based on the probability that the proposed inventory will sell. If the media plan has multiple budget level options, the sell-through probability of each option is considered and the inventory is reserved accordingly.

For purposes of the present invention, the term “admin data” refers to data entered into the system by a system administrator. This data may include user permission rights, rate card information, default settings, etc.

For purposes of the present invention, the term “ad network” refers to a publisher or media company who manages and sells ad inventory for multiple websites or other digital properties. Ad network may also refer to the websites or digital properties themselves, e.g., a network of websites.

For purposes of the present invention, the term “ad placement” refers to an ad unit that's characterized by location, targeting criteria, and type, and whose inventory has been proposed or sold to an advertiser on a media plan. An ad placement can also consist of multiple ad units that are grouped together as one deliverable, i.e. the delivered inventory from each ad unit contributes to one aggregate delivery goal for the respective ad placement. For example, a publisher might propose a “homepage takeover” on a website, which may be considered a single ad placement even if there are multiple ad units on the website's homepage.

For purposes of the present invention, the term “ad server” refers to a computer server or network of computer servers that stores and delivers ad creative to a digital medium; records these ad serving events, e.g., ad impressions and ad clicks; and a graphical user interface allowing a user to manage the delivery of advertising to a digital medium.

For purposes of the present invention, the term “ad serving data” refers to data collected and stored by an ad server, which pertains to the advertisements served by the publisher's ad server or other ad servers. Such data may include ad impressions, ad clicks, viewable ad impressions, time displayed, ad revenue, video plays, video completes, etc.

For the purposes of the present invention, the term “ad trafficking” refers to a process wherein creative assets are uploaded to an ad server so that the ad server can display the creative on a digital medium, such as a webpage.

For purposes of the present invention, the term “ad unit” refers to the space on a digital medium, such as a webpage, that contains an advertisement. This space is often characterized by its dimension in pixels, such as 728 pixels wide by 90 pixels tall (728×90) and by file format, such as image, text, or video. Ad units can take a variety of forms and types, ranging from standard dimensions and formats that are common to most publishers, to those that are unique to a given publisher.

For purposes of the present invention, the term “advertiser” refers not only to a buyer or prospective buyer of advertising space, but also a third party, such as an advertising agency which acts on behalf of the buyer. Most companies with large advertising budgets are represented by ad agencies and may have minimal communication with the publisher directly.

For purposes of the present invention, the term “advertiser history” refers to historical information about a specific advertiser. This information may consist of contact information, the campaign criteria of previous media plans an advertiser has received or bought, notes regarding that advertiser, publisher personnel who worked with that advertiser in the past, etc.

For purposes of the present invention, the term “automatic” and the term “automatically” refer to a process or step that is performed by a computer or other electronic device without human intervention.

For purposes of the present invention, the term “available inventory” refers to inventory that has not yet been sold to or has been reserved for an advertiser.

For purposes of the present invention, the term “booked inventory,” the term “contracted inventory,” the term “reserved inventory,” the term “sold inventory” and the term “unavailable inventory” refer to inventory that has been sold to or reserved for an advertiser, i.e., inventory that is ineligible to be proposed or sold to another advertiser.

For the purposes of the present invention, the term “campaign budget” refers to the amount of money an advertiser will pay a publisher for the advertising of a given ad campaign. It's common for a publisher to create a media plan presenting multiple budget options of varying costs because it's uncertain how much of a larger campaign budget the publisher will get from the advertiser. The “larger campaign budget” refers to the campaign budget from the advertiser's perspective. Publishers will often present the media plan by making the higher budget option more appealing to the advertiser, i.e., providing more value for the cost, which incentivizes the advertiser to spend more with the publisher.

For purposes of the present invention, the term “campaign criteria” refers to the parameters of an ad campaign. These parameters may include the proposal name, advertiser history, the campaign budget or multiple budget options, applicable target groups, the campaign flight or flights, the type of ad units the advertiser wants to buy, where those ad units will display, and to whom those ad units will display, i.e. the target audience. Additional criteria may include day-part targeting, frequency capping, as well as the sell-through probability of each budget option. Delivery goals and rates may also be considered campaign criteria, however, these criteria are not necessarily entered by a user, but instead are derived by the system. These campaign criteria dictate the nature of the ad placements, which collectively comprise the media plan.

For the purposes of the present invention, the term “campaign flight” refers to the time period from when an ad campaign is scheduled to start displaying its first ad placement to when the ad campaign is scheduled to stop displaying its last ad placement, wherein each ad placement shares a common objective. A campaign may have multiple campaign flights if it has multiple objectives. For example, it may display creative A in campaign flight 1, and creative B in campaign flight 2. In this scenario, an ad campaign may have two campaign flights.

For purposes of the present invention, the term “competing ad placement” refers to an ad placement that shares common targeting criteria as another ad placement that's also eligible to serve at the same time. Competing ad placements draw from the same pool of inventory, and therefore, they compete for that inventory; more contracted inventory for one ad placement results in less available inventory for the competing ad placement.

For purposes of the present invention, the term “computer” refers to any type of computer or other device that implements software including an individual computer such as a personal computer, laptop computer, tablet computer, mainframe computer, mini-computer, etc. A computer also refers to electronic devices such as an electronic scientific instrument such as a spectrometer, a smartphone, an eBook reader, a cell phone, a television, a handheld electronic game console, a videogame console, a compressed audio or video player such as an MP3 player, a Blu-ray player, a DVD player, etc. In addition, the term “computer” refers to any type of network of computers, such as a network of computers in a business, a computer bank, the Cloud, the Internet, etc. Various processes of the present invention may be carried out using a computer. Various functions of the present invention may be performed by one or more computers.

For the purposes of the present invention, the term “cost-per-thousand” and the term “CPM” refer to a rate method based on impressions. An ad placement transacting on a cost-per-thousand (CPM) basis will have a defined price for every one thousand impressions delivered. For example, if an ad placement has a $5 CPM, the advertiser agrees to pay the publisher $5 each time that ad placement displays one thousand times.

For the purposes of the present invention, the term “creative specifications” refers to qualities of an advertisement's creative file. For example, this might include the file size in kilobytes, e.g. 40 kb; the file type, e.g. .jpg, .gif, .swf; the maximum duration the file can be animated, e.g. 0:15 seconds; etc.

For the purposes of the present invention, the term “day-part targeting” refers to a setting within an ad server or system that controls the time of day and the day of week an ad placement is eligible to serve. For example, an ad placement may only be eligible to serve on Monday, 9 am-5 pm, which can be controlled by the ad server.

For the purposes of the present invention, the term “delivery goal” refers to the amount of inventory that's proposed or contracted for an ad placement on a media plan.

For purposes of the present invention, the term “delivery metric” refers to ad serving data. These ad serving data are used as the unit of measurement to quantify the value of each ad placement on a media plan. Each ad placement on a media plan will have a delivery metric, e.g., ad impressions, ad clicks, viewable ad impressions, time displayed, video plays, video completes, etc. It is incumbent upon the publisher to display each ad placement frequently enough to reach the ad placement's respective delivery goal.

For purposes of the present invention, the term “delivery metric inventory” and the term “inventory”, unless specified otherwise, refer to the aggregate quantity of a delivery metric, such as: impressions, viewable impressions, clicks, etc., that an ad placement will yield for a defined period of time in the future.

For the purposes of the present invention, the term “double-booking” refers to an event wherein a publisher sells two fixed ad placements that are considered competing ad placements.

For purposes of the present invention, the term “fixed ad placement” refers to an ad placement that persistently occupies the same ad unit and location for the entire course of its flight. For example, consider the fixed ad placement, “homepage takeover.” This ad placement will display on the homepage every time a user visits the homepage, and it will continue to display during that period even when the page is refreshed by the same user or visited by other users from different computers. The ad placement will only stop displaying when the ad placement reaches the ad placement's scheduled end date.

For the purposes of the present invention, the term, “fixed placement minimum” refers to a minimum percentage of given target group's budget that must be allocated to a fixed ad placement or fixed ad placements within that target group. The fixed placement minimum is set by a user administrator and is applied to all media plans created within that administrator's site or ad network thereafter. If the administrator sets the fixed placement minimum to 25%, for example, the aggregate cost of the fixed ad placements would equal at least 25% of the budget allocated to the target group containing those fixed ad placements.

For purposes of the present invention, the term “flight date” and the term “flight” refer to the period of time in which an ad placement is scheduled to display.

For purposes of the present invention, the term “full delivery” refers to an event wherein the amount of delivered inventory equals the amount of sold inventory for a given ad placement.

For the purposes of the present invention, the term “frequency capping” refers to a setting within an ad server or system that controls the frequency at which a given ad placement is eligible to display to a user. A variety of frequencies may be applied, such as n times per minute, n times per hour, n times per day, n times per week, n times per month, or n times per ad placement flight. Combinations of frequency capping may also be applied to a given ad placement, such as one time per day and three times per week.

For purposes of the present invention, the term “hardware and/or software” refers to functions that may be performed by digital software, digital hardware, or a combination of both digital hardware and digital software.

For purposes of the present invention, the term “historical rate” refers to the price of an ad placement that was proposed or sold to an advertiser on a previous media plan. Advertisers often expect rates that have been proposed or sold to them in the past. Therefore, it is incumbent on the publisher to keep record of historical rates as they can vary for each advertiser.

For the purposes of the present invention, the term “label” refers to a targeting criterion and a setting within an ad server or system that classifies an advertiser into a given category for the purpose of identifying the advertiser as part of such a category, which gives the ad server further control over how the ad may be served. Once identified as belonging to a given category, e.g. “automotive advertiser,” “clothing advertiser,” “liquor advertiser,” etc., the ad server can prevent similar advertisers from displaying next to each other.

For purposes of the present invention, the term “machine-readable medium” refers to any tangible or non-transitory medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” includes, but is not limited to, solid-state memories, and optical and magnetic media. Specific examples of machine-readable media include non-volatile memory, including by way of example, semiconductor memory devices, e.g., EPROM, EEPROM, and flash memory devices; magnetic disks such as internal hard disks and removable disks; magneto-optical disks; and CD-ROM and DVD-ROM disks. The term “machine-readable medium” may include a single medium or multiple media (e.g., a centralized or distributed database, and/or associated caches and servers) that store the one or more instructions or data structures.

For purposes of the present invention, the term “media” refers to ad placements in a general sense. For example, one might say, “I want to buy media on your website,” meaning, “I want to buy ad placements on your website.”

For purposes of the present invention, the term “media plan” refers to an agreement between publisher and advertiser that stipulates the parameters of the ad campaign. These parameters include the campaign criteria: the proposal name, the advertiser history, the campaign budget or multiple budget options, applicable target groups, the campaign flight or flights, the type of ad units the advertiser wants to buy, delivery goals, rates, where the ad units will display, and to whom those ad units will display, i.e. the target audience. Additional criteria may include day-part targeting and frequency capping. Other criteria can also be included, such as the total inventory of a proposed ad placement, the share of voice, creative specifications of the ad unit, publisher and advertiser contact information, as well as terms and conditions of the agreement. The term can be used interchangeably with “Proposal,” “Insertion Order,” “Purchase Order,” “Media Grid,” “Order,” or “Deal.”

For purposes of the present invention, the term “network taxonomy” refers to the way ad units are organized and classified across websites or other digital properties within the same ad network. Ad units that are available on one website, for example, may not be available on another website within the same ad network, and vice versa.

For purposes of the present invention, the term “optimal inventory allocation” refers to an automated allocation of inventory to a given ad placement for the purpose of setting a delivery goal that meets predefined objectives of the publisher. In one embodiment of the present invention, the optimal inventory allocation is one that sets the delivery goals of each ad placement on the media plan based on the available inventory of each ad placement. Whatever the objective, the optimization is predefined so that the delivery goals of each ad placement are automated by the system.

For purposes of the present invention, the term “optimal rate” refers to the price of an ad placement that is automatically determined by the system and automatically adjusts with demand for that ad placement. As inventory for a given ad placement becomes scarce, the price for that ad placement will increase until it reaches a predefined price ceiling, and conversely, as inventory becomes more abundant, the price will decrease until it reaches a predefined price floor.

For purposes of the present invention, the term “order” refers to campaign information and criteria that are stored in an ad server for a specific ad campaign. The term “media plan” can be used synonymously with “order” because the two have identical information. However, “order” is the more common terminology when this information is stored in an ad server, while “media plan” is the more common terminology when referring to the agreement or contract defining the parameters of the ad campaign.

For purposes of the present invention, the term “processor” refers to a device that performs the basic operations in a computer. A microprocessor is one example of a processor. Various functions of the present invention may be performed by one or more processors.

For purposes of the present invention, the term “proposal in market” refers to a media plan that has been submitted to an advertiser, but has not yet been sold and is still eligible to sell, i.e. the start date has not passed and the advertiser has not rejected the media plan.

For purposes of the present invention, the term “proposed ad placement” refers to an ad placement that has been proposed to an advertiser on a media plan, but has not yet been sold.

For the purposes of the present invention, the term “proposed inventory” refers to inventory that's been proposed to an advertiser on a media plan, but has not yet been sold.

For purposes of the present invention, the term “publisher” refers to someone who sells or manages advertising space on a digital medium. The term can be used interchangeably with “Media Company.”

For purposes of the present invention, the term “rate card” refers to established prices for each ad placement that a publisher could potentially sell. While prices might fluctuate depending on negotiations with a given advertiser, the rate card provides a benchmark for each ad placement's price.

For purposes of the present invention, the term “rate card price ceiling” refers to the highest price a publisher sets for a given ad placement on a rate card.

For purposes of the present invention, the term “rate card price floor” refers to the lowest price a publisher sets for a given ad placement on a rate card.

For the purposes of the present invention, the term, “rate method” refers to the cost structure the advertiser agrees to follow for payment of each ad placement. For example, the advertiser may agree to pay a set amount for every thousand impressions served (cost-per-thousand (CPM)), the advertiser may pay a set amount for every click recorded (cost-per-click (CPC)), the advertiser may pay the full cost of the ad placement up front as one “flat fee,” etc.

For purposes of the present invention, the term “rotational ad placement” refers to an ad placement that serves as frequently as necessary to reach a predetermined delivery goal. Therefore, the ad placement displays intermittently and does not necessarily display in the same location every time. If the rotational ad placement has a relatively large delivery goal, it will serve more frequently, and if it has a relatively small delivery goal, it will serve less frequently. For example, consider the rotational ad placements A, B, and C. If a user visits a webpage containing one ad unit and gets ad placement A, another user may visit the same webpage at the same time and get ad placement B. When each user refreshes the webpage, they each may get ad placement C.

For purposes of the present invention, the term “select a button” refers to any means of selecting and/or activating a button on a graphical user interface. For example, a button may be “selected” by touching a portion of a touchscreen over a button, by pressing a key of a keyboard interface, by clicking on a button using a mouse, etc.

For purposes of the present invention, the term “sell-through probability” refers to the probability that a proposed media plan will sell, which may also be understood as the probability that the ad placements included on that media plan will sell. This may be an estimate based on the publisher's best judgment or a calculation made by the system based on historical data.

For purposes of the present invention, the term “site taxonomy” refers to the way ad units are organized and classified within a website or other digital property. The ad units available in one section of a website, for example, may not be available in a different section of that website, and vice versa.

For the purposes of the present invention, the term “share of voice” and the term “SOV” refer to a percentage equaling the amount of proposed inventory or contracted inventory of a given ad placement, divided by the total inventory that an ad placement would yield if the ad placement weren't constrained by competing ad placements or cost restrictions. For example, if an ad placement had 50,000 contracted impressions, and that ad placement would deliver 100,000 impressions if there were no other ad placements competing for the same inventory, and the cost of those impressions was negligible, the SOV would be 50%.

For purposes of the present invention, the term “storage medium” refers to any medium or media on which data may be stored for use by a computer system. Examples of storage include both volatile and non-volatile memories such as MRAM, ERAM, flash memory, RFID tags, floppy disks, Zip™ disks, CD-ROM, CD-R, CD-RW, DVD, DVD-R, flash memory, hard disks, optical disks, etc.

For purposes of the present invention, the term “system” refers to a combination of hardware and/or software that may be used to implement one or more methods or processes of the present invention. A system may include one or more computers, a graphical user interface, etc. A system may comprise a number of computers connected to each other over the Internet and/or as part of a network.

For the purposes of the present invention, the term “target audience” refers to a group of people who represent consumers or potential consumers that an advertiser is trying to reach with an advertising message. This target audience may be people of a certain geographic location, people of a certain demographic, people with certain interests or behaviors, e.g. people who watch basketball on TV, people who view the advertisement on a given device, e.g. smartphone, tablet, etc., people who view the advertisement on a given web browser, etc.

For the purposes of the present invention, the term “targeting criteria” refers to the settings applied within an ad server or system used to reach a target audience. These settings may be used to reach people of a certain geographic location, people of a certain demographic, people with certain interests or behaviors, e.g. people who watch basketball on TV, people who view the advertisement on a given device, e.g. smartphone, tablet, etc., people who view the advertisement on a given web browser, etc. Targeting criteria may also be more broadly understood as the criteria applied within an ad server that gives the ad placement the coordinates to its final destination, i.e. where the ad placement displays and to whom it displays.

For purposes of the present invention, the term “target group” refers to any type of ad placement or ad placements that represents a percentage of the campaign budget. For example, an advertiser might request that half of the campaign budget be allocated to mobile ad placements and the other half be allocated to desktop ad placements. Both mobile ad placements and desktop ad placements would each be considered a target group.

For the purposes of the present invention, term “target group budget” refers to the percentage of the campaign budget allocated to a given target group, and the currency value of that percentage.

For purposes of the present invention, the term “under delivery” refers to an event in which the number of delivered impressions is less than the number of sold impressions after the ad placement has reached its scheduled end time.

For purposes of the present invention, the term “visual display device,” the term “visual display apparatus” and the term “visual display” refer to any type of visual display device or apparatus such as an LCD screen, touchscreen, a CRT monitor, LEDs, a projected display, a printer for printing out an image such as a picture and/or text, etc. A visual display device may be a part of another device such as a spectrometer, a computer monitor, a television, a projector, a cell phone, a smartphone, a laptop computer, a tablet computer, a handheld music and/or video player, a personal data assistant (PDA), a handheld game player, a head mounted display, a heads-up display (HUD), a global positioning system (GPS) receiver, etc.

### Description

Advertisers can buy ad space on a website or digital application by first requesting a media plan from the publisher of that website or digital application. This media plan may stipulate the type of ads that will be served, how the ads that will be served, how many ads will be served, at what cost, and for what period(s) of time. Media plans can become very complex because they require a multitude of parameters, including information that's difficult to find, is unreliable, or may even be unavailable.

Publishers often struggle to determine the amount of available inventory that can and should be proposed for each ad placement because variables such as the location of the ad placement, target audience, campaign flight, and competing ad placements all influence the ad placement's available inventory. In order to account for all of these variables and attain an accurate inventory estimate, the publisher must reference his or her ad server. However, the ad server's inventory estimates can be unreliable if the publisher fails to provide the ad server with complete information. Failure to provide the ad server with complete information can occur because media plans are often created in spreadsheet files, such as Microsoft Excel, and it can be time-consuming to enter the information from the spreadsheet into the ad server. This transfer of information can either be delayed or not done at all. When the ad server can't account for inventory that's been proposed, it may inform the publisher that there is more inventory available than the publisher actually has. This inaccurate inventory estimate results in under delivery because the publisher has proposed more inventory than is actually available.

Even when the publisher can confidently rely on the amount of available inventory, more time is spent assessing how much inventory is the right amount to propose to the advertiser. The right amount may not only be an amount that's appealing to the advertiser, but also one that serves the publisher's best interest. For example, the publisher may not want to propose all of one type of inventory because there is opportunity to sell that inventory to other advertisers at a higher rate. Therefore, the publisher must not only assess how much inventory is available, but also how much inventory should be proposed.

The rate for each ad placement can also vary and be equally difficult to determine For example, the same ad unit (e.g. 728×90 Leaderboard) can have a different rate depending on where it's displayed, when it's displayed, the target audience, and the advertiser history. Therefore, the publisher may need to reference a rate card for each ad placement, or spend time reviewing historical rate information from previous media plans.

Additional time is spent in the media planning process due to scheduling conflicts. The publisher must manage a calendar of fixed ad placements and reference this calendar while creating the media plan in order to avoid double-booking. When there are many competing ad placements, it can be time-consuming to find available flight dates for fixed ad placements.

In addition to time spent gathering all the necessary information, analyzing the media offering, and entering the data into the ad server, the media planning process is also inefficient because delivery goals are often less than optimal, either due to poor forecasting by the ad server, which is exacerbated when media plans are not immediately communicated to the ad server, or by human error. Inaccurate delivery goals lead to under or over delivery, which directly results in lost revenue for the publisher or more time spent trying to fix these errors.

In one embodiment, the present invention provides a system that automates delivery goals for ad placements on a media plan, proposal, insertion order, purchase order, deal, or any other agreement that defines the parameters of an ad campaign displayed on a digital medium.

In one embodiment, the present invention provides a system that automates the price or rate of ad placements on a media plan, proposal, insertion order, purchase order, deal, or any other agreement that defines the parameters of an ad campaign displayed on a digital medium.

In one embodiment, the present invention provides a system that automates the flight date of fixed ad placements on a media plan, proposal, insertion order, purchase order, deal, or any other agreement that defines the parameters of an ad campaign displayed on a digital medium.

In one embodiment, the present invention provides a method of reserving inventory for ad placements on a media plan, proposal, insertion order, purchase order, deal, or any other agreement that defines the parameters of an ad campaign displayed on a digital medium. In one embodiment of the present invention, such a method may be based on the sell-through probability of the ad campaign.

In one embodiment, the present invention provides a method of determining the price or rate of ad placements on a media plan, proposal, insertion order, purchase order, deal, or any other agreement that defines the parameters of an ad campaign displayed on a digital medium. In one embodiment of the present invention, such a method may be based on the inventory available.

In one embodiment, the present invention provides a method of reserving flight dates of fixed ad placements on a media plan, proposal, insertion order, purchase order, deal, or any other agreement that defines the parameters of an ad campaign displayed on a digital medium. In one embodiment of the present invention, such a method may be based on the sell-through probability of the ad campaign.

In one embodiment, the present invention provides a system that consolidates advertising campaign information, automates the media planning process by determining the optimal inventory allocation for each ad placement, the optimal or historical rate for each ad placement, the flight dates for each fixed ad placement, and pushes the media plan to the ad server so that manual data entry is reduced.

In one embodiment, the present invention provides a method and apparatus that pulls campaign criteria from a plurality of servers and databases, including a publisher's ad server, and processes user-input campaign criteria to generate a media plan wherein delivery goals and rates for each ad placement, and flights for each fixed ad placement are determined by the system. Within the parameters of an advertiser's budget, each delivery goal is determined based on the available inventory for that ad placement and the available inventory of the other ad placements included on the media plan. Computer software adjusts the values of an ad placement's rate based on the available inventory of the respective ad placement and the rate card price floor and rate card price ceiling of the respective ad placement. While the initial allocation of inventory and the rate of each ad placement are automated, there is an interface wherein a user can edit these values to meet the advertiser's specific needs. This media plan can then be sent to the advertiser via the system and pushed to the publisher's ad server as an order ready to receive creative assets for trafficking.

In one embodiment, the present invention provides a system, method, and computer program that pulls campaign criteria from a plurality of servers and databases, including a publisher's ad server, and processes user-input campaign criteria to generate a media plan wherein delivery goals and rates for each ad placement, and flights for each fixed ad placement are determined by the system. Within the parameters of an advertiser's budget, each delivery goal is determined based on the available inventory for that ad placement and the available inventory of the other ad placements included on the media plan. Computer software adjusts the values of an ad placement's rate based on the available inventory of the respective ad placement and the rate card price floor and rate card price ceiling of the respective ad placement. While the initial allocation of inventory and the rate of each ad placement are automated, there is an interface wherein a user can edit these values to meet the advertiser's specific needs. This media plan can then be sent to the advertiser via the system and pushed to the publisher's ad server as an order ready to receive creative assets for trafficking.

In one embodiment, the present invention provides an advertiser-facing interface that facilitates a collaborative workflow via the system, wherein the publisher can submit the media plan to the advertiser and the advertiser can submit notifications to the publisher.

In one embodiment, the present invention provides a calendar feature. The calendar helps the publisher avoid double-booking. The system prevents double-booking by tracking the reservations of all fixed ad placements and either chooses the first available flight date or the flight date with the lowest sell-through probability. If the publisher needs a specific flight date for a fixed ad placement, that flight date can be chosen by referencing the calendar, which tracks the flight dates of all fixed ad placements once they're added to a media plan.

In one embodiment, the present invention provides a reporting feature. This reporting feature allows the publisher to view past ad serving data as well as predict future ad serving data.

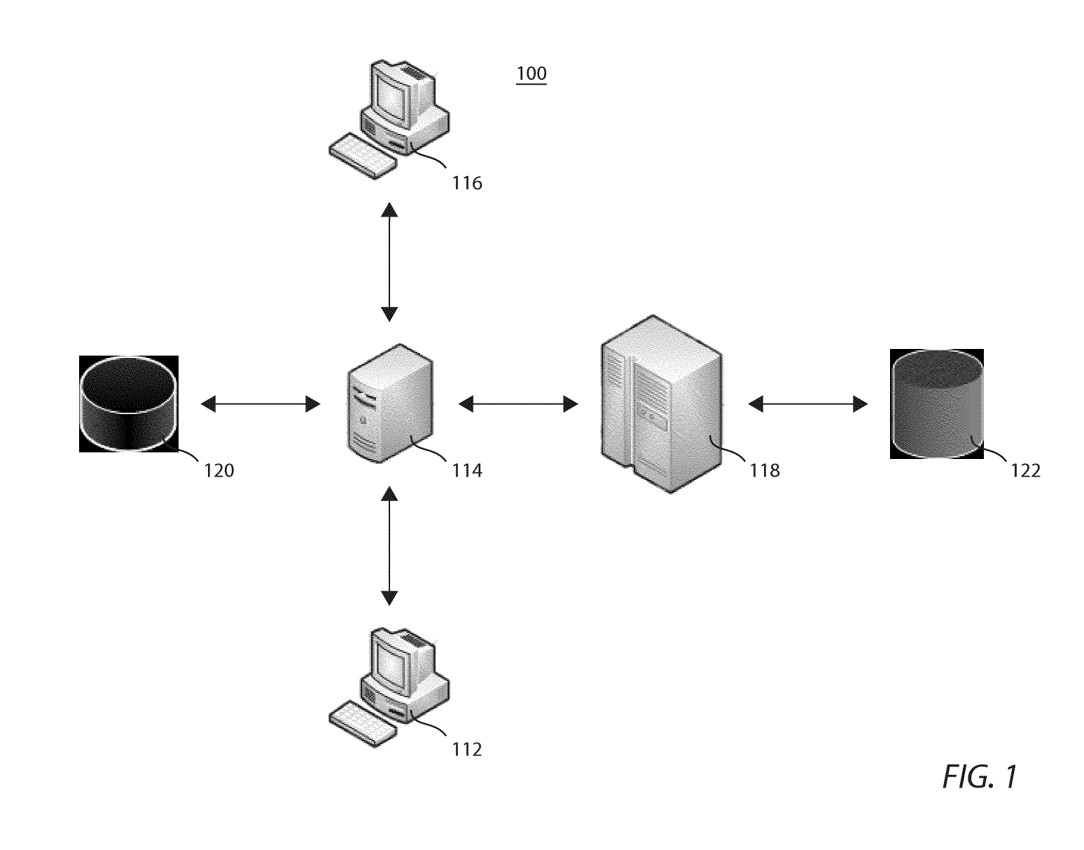

FIG. 1 is a diagram illustrating a process 100 for the general exchange of information stemming from a system according to one embodiment of the present invention. A publisher-facing graphical user interface of a publisher's computer 112 allows the publisher to enter campaign criteria and admin data into a system 114 for the general purpose of creating a media plan and sending the media plan to an advertiser's computer 116. System 114 communicates with a publisher's ad server 118, which provides network taxonomy and site taxonomy information, and delivery metric inventory by pulling this information from the ad server's database 122. A database 120 communicates directly with the system, providing rate information, advertising specifications, admin data, and scheduling information (i.e. fixed ad placement flight dates). An advertiser-facing graphical user interface of advertiser's computer 116 allows the advertiser to receive media plans and reporting information, such as campaign delivery information. The advertiser-facing graphical user interface also allows the advertiser to send notifications back to the publisher, such as a notification stating that the media plan has been approved, the media plan needs to be revised, or the media plan has been rejected.

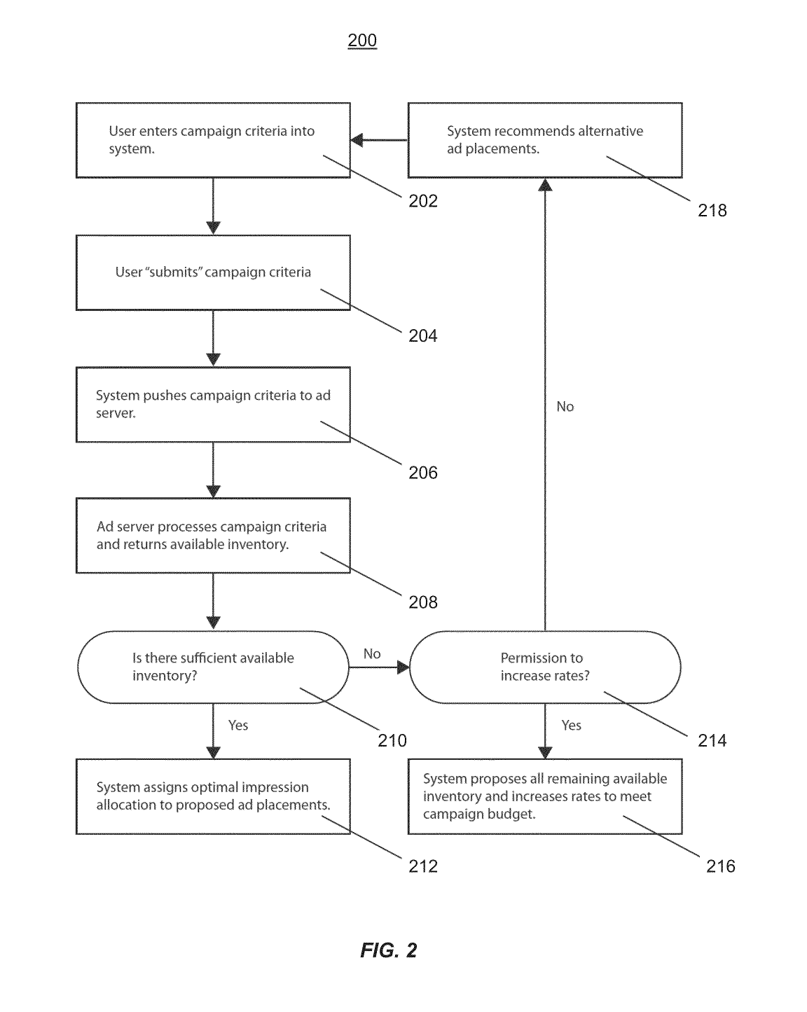

FIG. 2 shows a method 200 according to one embodiment of the present invention of generating a media plan based on campaign criteria entered by a user, such as a publisher. At step 202 the user enters campaign criteria into the system via a graphical user interface. The system may be understood as a combination of hardware and software used to carry out various methods and process of the present invention as described herein. These criteria include the advertiser name, the proposal name, the campaign budget or multiple budget options, the sell-through probability of each budget option, the campaign flight or flights, the type of ad units, where those ad units will display and optionally the user may also define the target audience, include target groups, day-part targeting, and frequency capping. These criteria comprise the ad placements proposed by the media plan. At step 204 the user “submits” campaign criteria by selecting a button on a graphical user interface, for example. At step 206 the system pushes campaign criteria to the ad server. These criteria include the advertiser name, the proposal name, the type of ad units, the flight of each ad placement, and targeting criteria of each ad placement. At step 208 the ad server processes the campaign criteria and returns the available inventory of each ad placement. At step 210 the system determines if there is sufficient available inventory. It should be understood that the advertiser might want to purchase more inventory than the publisher has available. Therefore, the system must determine if the supply of inventory can meet the demand for inventory. If there is sufficient available inventory, the system assigns an optimal inventory allocation to all proposed ad placements at step 212. This optimal inventory allocation is based on the amount of available inventory found at step 208. However, if the system determines that there is insufficient available inventory for the proposed ad placements, the system will prompt the user with the option to increase the rates of each ad placement at step 214. The rate of each ad placement may or may not be eligible to change depending on the expectation of the advertiser. Returning advertisers, for example, often expect historical rates, while new advertisers may be eligible to receive higher, optimal rates. If the user allows the system to increase rates, the system will increase rates proportionately across all eligible ad placements until the campaign budget is met and all available inventory is allocated to each ad placement at step 216. If the user does not allow the system to increase rates, the system recommends alternative ad placements at step 218. These alternative ad placements can be any ad placement that has available inventory during the campaign flight. The user may then consider these alternative ad placements and repeat the process at step 202 by entering new campaign criteria, which may include these alternative ad placements.

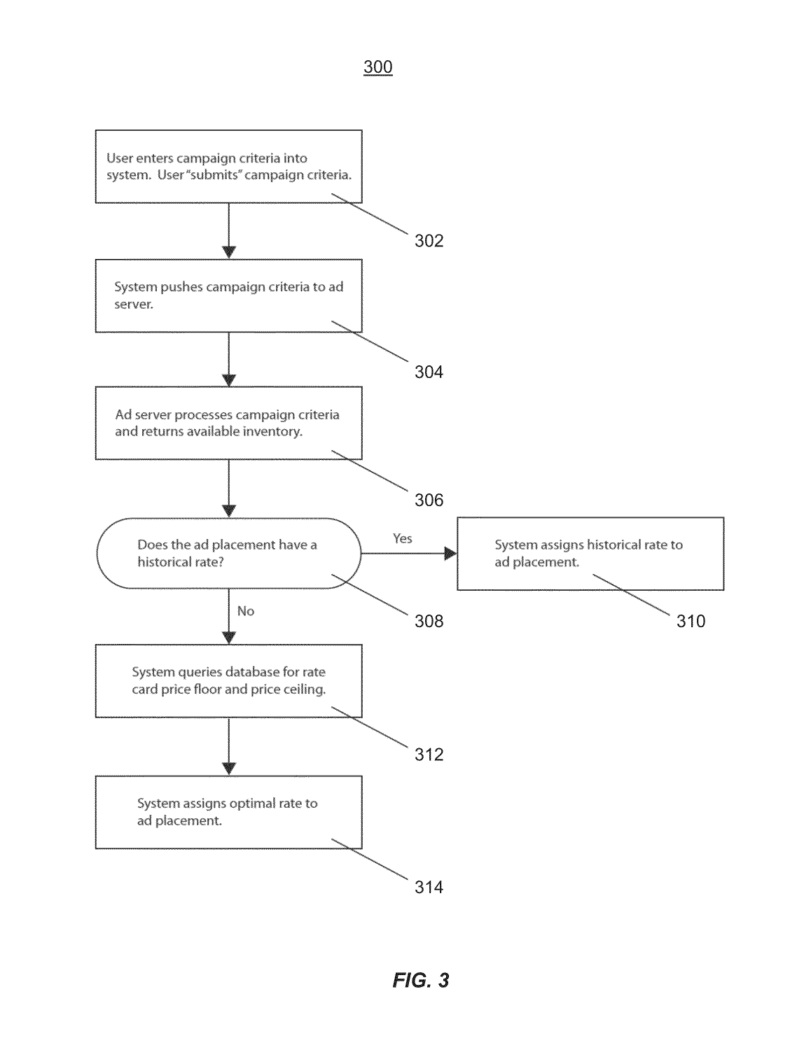

FIG. 3 shows a method 300 according to one embodiment of the present invention of how a system of the present invention assigns an optimal rate to an ad placement based on campaign criteria entered by a user, such as a publisher. At step 302, a user, such as a publisher enters campaign criteria. These criteria include the advertiser name, the proposal name, the campaign budget or multiple budget options, the sell-through probability of each budget option, the campaign flight or flights, the type of ad units, where those ad units will display, and optionally the user may also define the target audience, include target groups, day-part targeting, and frequency capping. These criteria comprise the ad placements proposed by the media plan. The user submits these criteria by selecting a button on a graphical user interface, for example. At step 304 the system pushes campaign criteria to an ad server. These criteria include the advertiser name, the proposal name, the type of ad units, the flight of each ad placement, and targeting criteria of each ad placement. The ad server processes this information and returns the available inventory of each ad placement at step 306. At step 308, the system determines if the ad placement has a historical rate by querying a database for prior ad placement information matching the input criteria: advertiser name, ad unit size, ad unit location, target audience and campaign flight. If the system matches these criteria to a historical rate, the system assigns the historical rate to the ad placement at step 310. If the system does not match these criteria to a historical rate, the system queries a database for a rate card price floor and a rate card price ceiling at step 312. The system determines the optimal rate for the ad placement at step 314 by considering the range between the rate card price floor and rate card price ceiling found at step 312, and the available inventory found at step 306. The greater the amount of available inventory, the closer the optimal rate will be to the price floor, and the smaller the amount of available inventory, the closer the optimal rate will be to the price ceiling. This automation allows the user to price inventory according to the demand for that inventory in real time.

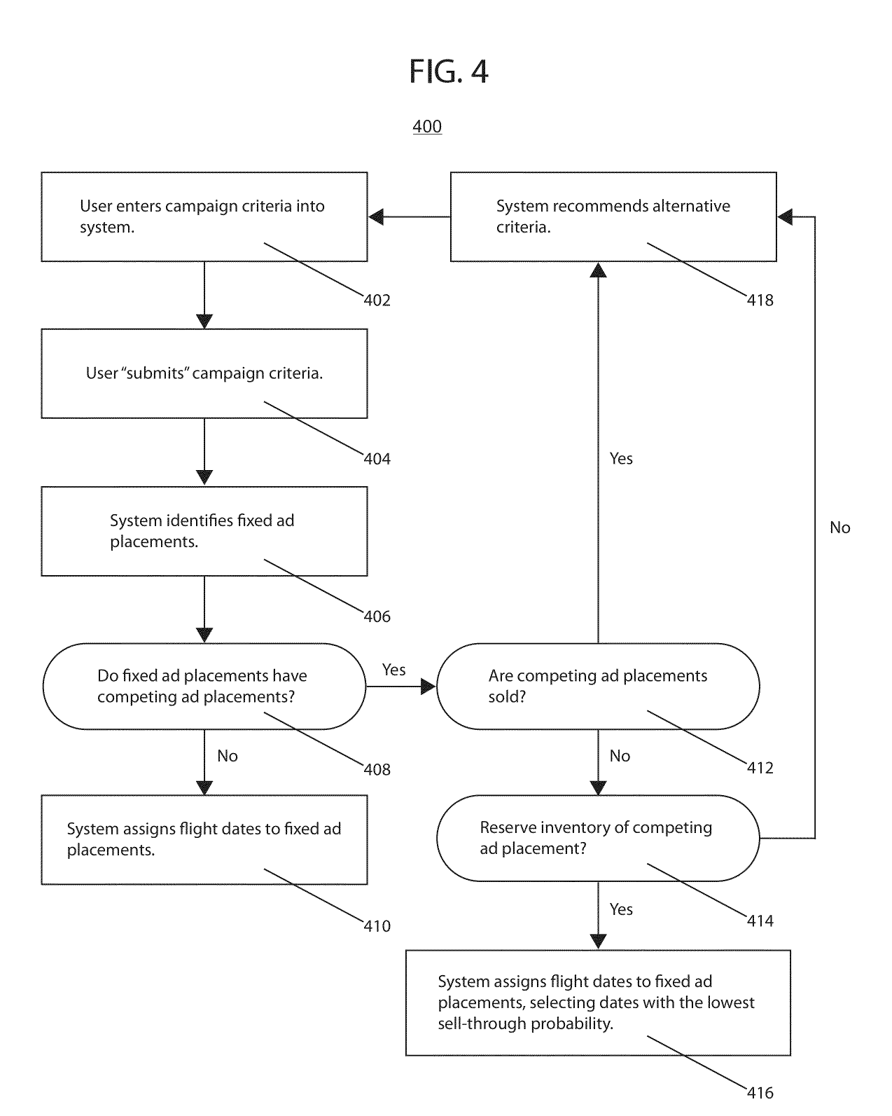

FIG. 4 shows a method 400 according to one embodiment of the present invention of how a system of the present invention assigns flight dates to fixed ad placements based on campaign criteria entered by a user, such as a publisher. At step 402 the user enters campaign criteria into the system. These criteria include the advertiser name, the proposal name, the campaign budget or multiple budget options, the sell-through probability of each budget option, the campaign flight or flights, the type of ad units, where those ad units will display, and optionally the user may also define the target audience, target groups, day-part targeting, and frequency capping. At step 404 the user “submits” the information by selecting a button on a graphical user interface, for example. At step 406, the system identifies any fixed ad placements that have been entered by the user. At step 408, the system determines if the fixed ad placements have competing ad placements by querying a database for the following ad placement criteria: ad unit type (i.e. fixed), ad placement location (e.g. “Example.com/news”), and ad placement flight. If at step 408 the system determines that the fixed ad placements do not have competing ad placements, i.e. there is not an existing match for the same ad placement criteria, at step 410 the system assigns the first available date within the campaign flight to the fixed ad placement, which is stored in a database and displayed on both the media plan and a calendar, which are both displayed on a graphical user interface. If at step 408 the system determines that the fixed ad placement does have a competing ad placement, at step 412 the system determines if the competing ad placement is sold. If at step 412 the system determines that the competing ad placement is not sold, at step 414 the system asks permission from the user to reserve a date that's already been reserved by a competing ad placement. If at step 414 the user allows the system to reserve the inventory of a competing ad placement, at step 416 the system assigns a flight date to the fixed ad placement by selecting the date that's been reserved by the competing ad placement with the lowest sell-through probability. For example, if there are two eligible dates to which to assign the fixed ad placement, and one is already reserved by a competing ad placement with a 10% sell-through probability, and the other date is already reserved by a competing ad placement with a 50% sell-through probability, the system will choose the date that's reserved by the competing ad placement with the 10% sell-through probability. It should be understood that a date could be reserved by multiple fixed ad placements as long as none of the ad placements are sold. As soon as an ad placement is sold, the date becomes ineligible for reservations by competing ad placements. For dates being reserved by multiple competing ad placements, the probability that at least one ad placement will sell is considered in the date selection process. For example, a date being reserved by one competing ad placement with a 25% sell-through probability would be chosen over a date being reserved by ten competing ad placements each with a 10% sell-through probability. Once a date is chosen by the system, the information is stored in a database and displayed on both the media plan and a calendar, which are both displayed on a graphical user interface. In an alternative embodiment of the present invention, at step 414 the user may not allow the system to reserve the same date as one reserved by a competing ad placement, in which case the system recommends alternative criteria at step 418 that the user can enter as new campaign criteria at step 402, thereby causing method 400 to proceed again to step 404. In an alternative scenario, at step 412 the system may identify that all competing ad placements are sold, in which case the system recommends alternative criteria at step 418 that the user can enter as new campaign criteria at step 402, thereby causing method 400 to proceed again to step 404.

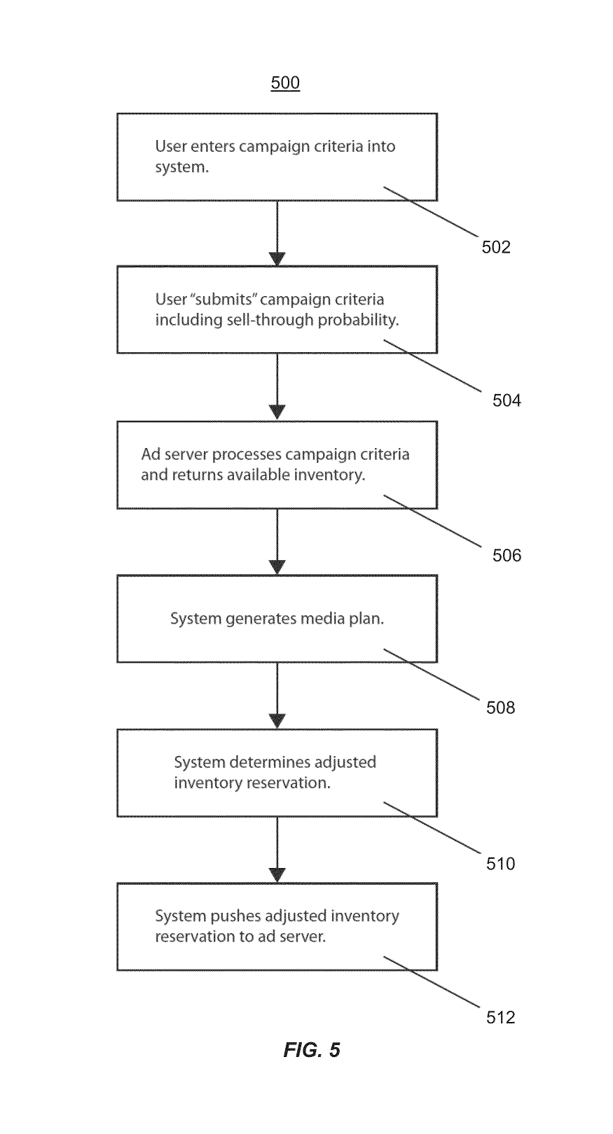

FIG. 5 shows a method 500 according to one embodiment of the present invention of how a system of the present invention pushes an adjusted inventory reservation to an ad server based on campaign criteria entered by a user, such as a publisher. At step 502 the user enters campaign criteria into the system. These criteria include the advertiser name, the proposal name, the campaign budget or multiple budget options, the sell-through probability of each budget option, the campaign flight or flights, the type of ad units, where those ad units will display, and optionally the user may also include target groups, define the target audience, day-part targeting, and frequency capping. At step 504 the user submits the campaign criteria. These criteria include the advertiser name, the proposal name, the type of ad units, the flight of each ad placement, and targeting criteria of each ad placement. At step 506 the ad server processes the campaign criteria and returns available inventory of each ad placement. At step 508, the system generates a media plan as described in previous figures. At step 510 the system determines an adjusted inventory reservation. This adjusted inventory reservation refers to the amount of inventory the system will send to the ad server to be reserved. This amount is discounted based on each budget option's sell-through probability. For example, a publisher may not want to reserve all of the inventory that's proposed on a media plan if that campaign only has a 10% probability of being sold. The publisher wouldn't want to reserve all of the inventory because reserving that inventory makes it unavailable to other advertisers who may be more likely to purchase that inventory. If a campaign has a small probability of being sold, the publisher may only wish to reserve a percentage of the proposed inventory proportionate to the probability that the campaign will sell. This adjusted inventory reservation is also applicable to multiple budget options for the same campaign. For example, a publisher might propose two budget options to the same advertiser: $5,000 and $10,000. It would be illogical to reserve all of the inventory for both budget options because the advertiser would only purchase the inventory for one. Therefore, the inventory that's reserved for the campaign would be an adjusted inventory reservation based on the sell-through probability of each budget option. At step 512 the system pushes the adjusted inventory reservation to the publisher's ad server, which stores the adjusted inventory reservation in a database and displays the adjusted inventory reservation to the user via a graphical user interface. Once reserved in the ad server, this inventory is “unavailable” to other advertisers. However, the reserved inventory would not be the full amount of proposed inventory until the campaign is sold.

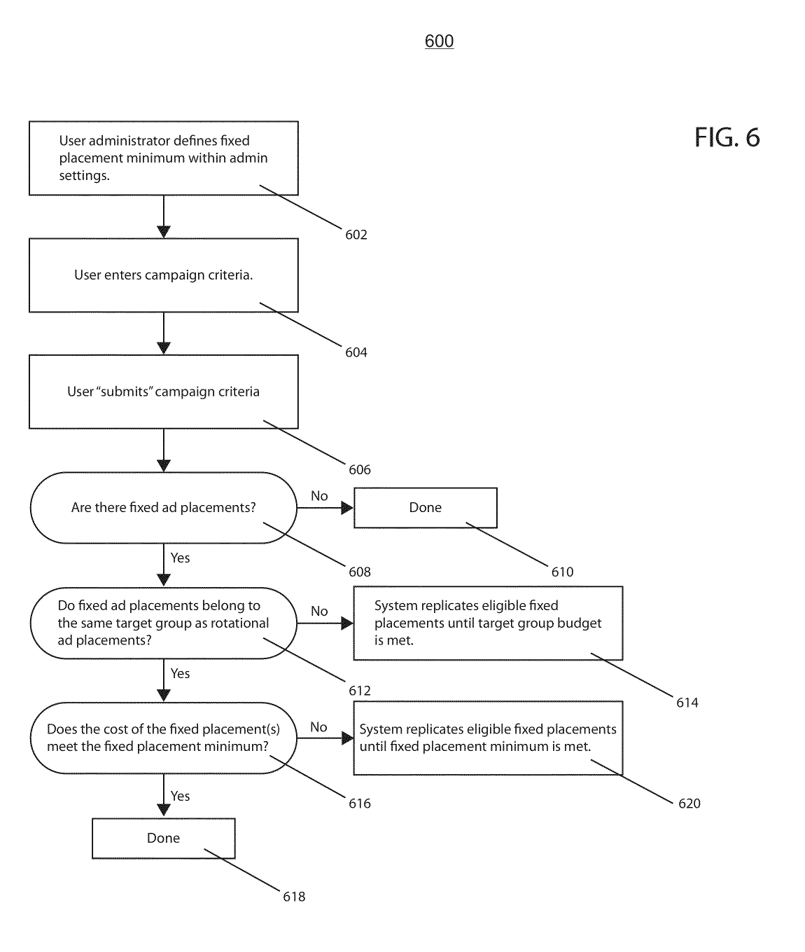

FIG. 6 shows a method 600 according to one embodiment of the present invention of how a system of the present invention recommends an action to replicate fixed ad placements on a media plan to meet a fixed placement minimum. At step 602, a user administrator, such as a publisher administrator, adjusts the system's settings, enabling the system to recommend that the cost of the fixed ad placement(s) contained within each target group of a media plan meet a certain minimum percentage of the target group budget, which can be done through a graphical user interface displaying administrative settings. This minimum cost has been defined as the fixed placement minimum herein. At step 604 a user, such as a publisher, enters campaign criteria into the system via a graphical user interface. These criteria include the advertiser name, the proposal name, the campaign budget or multiple budget options, the sell-through probability of each budget option, the campaign flight or flights, the type of ad units, where those ad units will display, and optionally the user may also define the target audience, target groups, day-part targeting, and frequency capping. At step 606, the user “submits” the campaign criteria by selecting a button via a graphical user interface, for example, for the purpose of creating a media plan as described in previous figures. At step 608, the system determines if there are fixed ad placements included on the media plan. If there are not one or more fixed ad placements included on the media plan, no further action is taken as indicated at step 610. If there are one or more fixed ad placements included in a given target group within the media plan, at step 612, the system determines if the target group has a mix of rotational and fixed ad placement types, or if it contains fixed ad placements only. If the target group contains fixed ad placements only, the system replicates the eligible fixed ad placements until the target group budget is met at step 614. It should be understood that the nature of the target group is to represent a given percentage of the campaign budget, and therefore in a scenario where only fixed ad placements are present within the target group, the system will continue to replicate the fixed ad placement(s) until the target group budget is met, which by definition will exceed the fixed placement minimum. At step 612, if the system determines that there is a mix of rotational and fixed ad placement types, the system determines if the fixed ad placement(s) meet the fixed placement minimum at step 616. If the fixed ad placements within the target group meet the fixed placement minimum, no further action is taken as indicated at step 618. If the system determines that the fixed ad placement(s) do not meet the fixed placement minimum at step 616, the system replicates the eligible fixed ad placement(s) until the fixed placement minimum is met at step 620. It should be understood that the user has the option to replicate the fixed ad placements beyond the fixed placement minimum. It should also be understood that the user may not explicitly define target groups as campaign criteria, in which case the system may consider a fixed placement minimum for the entire campaign budget, effectively treating the campaign budget as a single target group.

### EXAMPLES

### Example 1

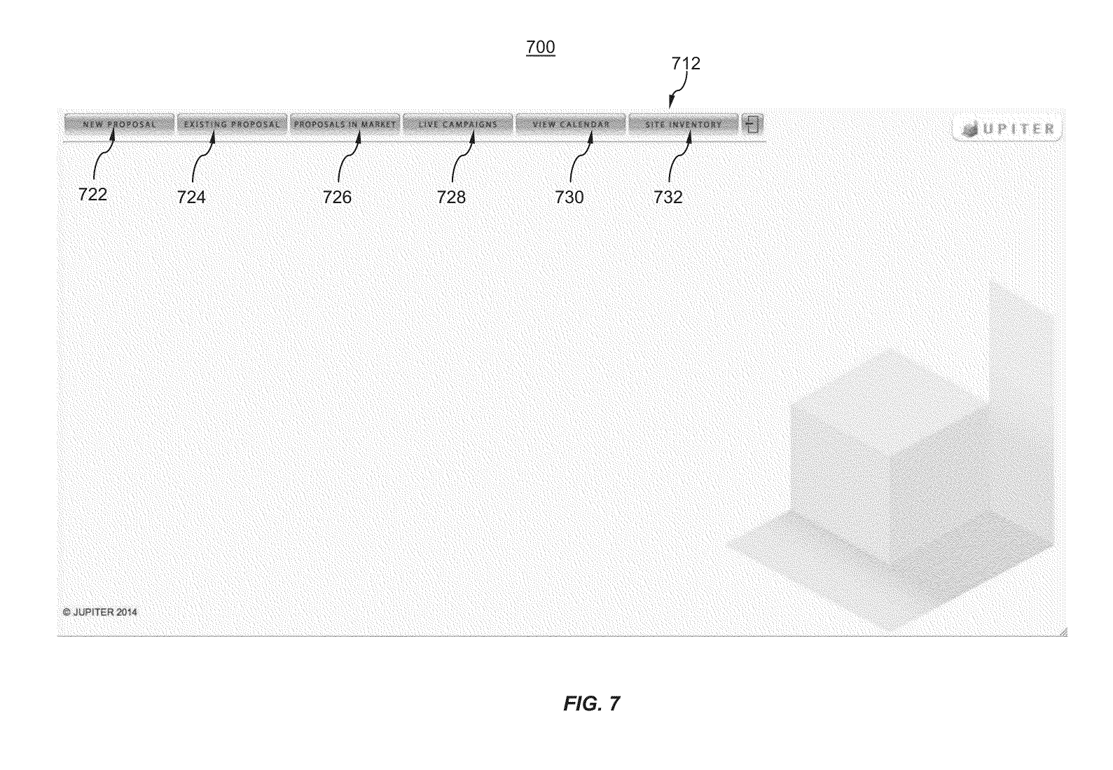

FIG. 7 shows a Homepage screen 700 of a graphical user interface of a system according to one embodiment of the present invention that is presented to a user. Homepage screen 700 includes a menu 712 having a New Proposal button 722, an Existing Proposal button 724, a Proposals in Market button 726, a Live Campaigns button 728, a View Calendar button 730 and Site Inventory button 732.

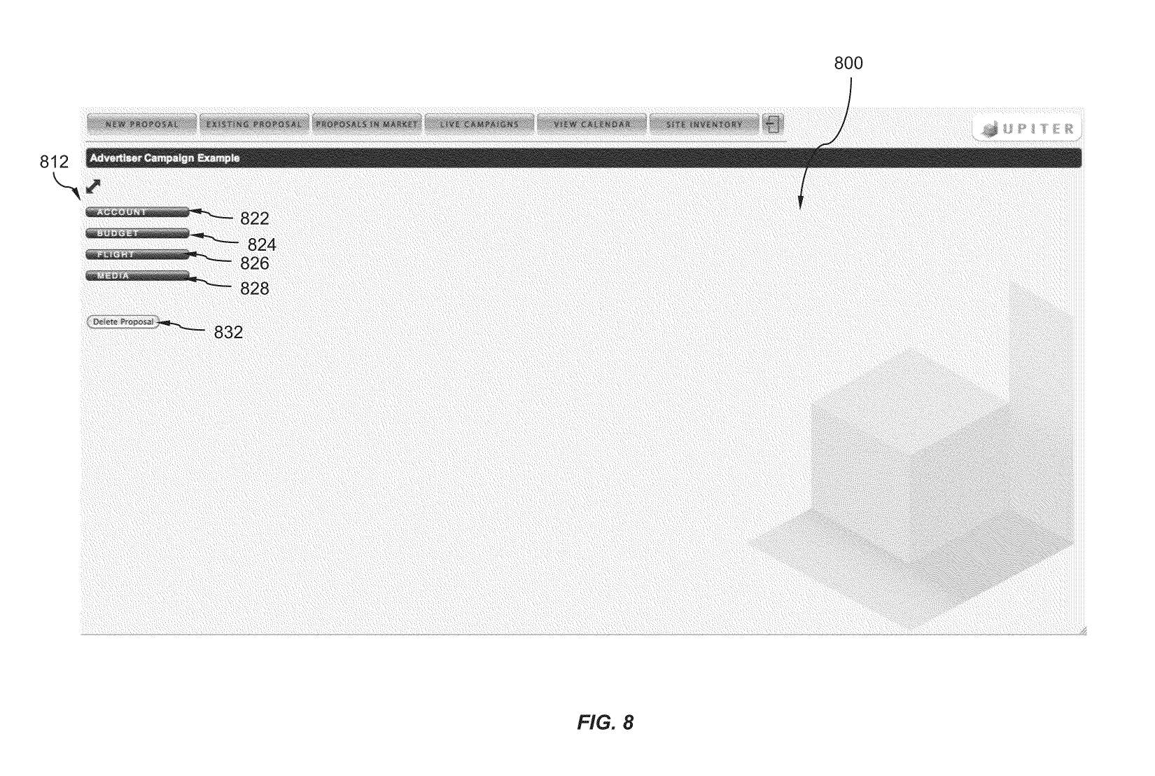

When the user selects New Proposal button 722 shown in FIG. 7, a Proposal window 800 appears as shown in FIG. 8 that allows a user to create a new proposal. Proposal window 800 includes a menu 812 having an Account button 822, a Budget button 824, a Flight button 826 and a Media button 828. Proposal window 800 also includes a Delete proposal button 832.

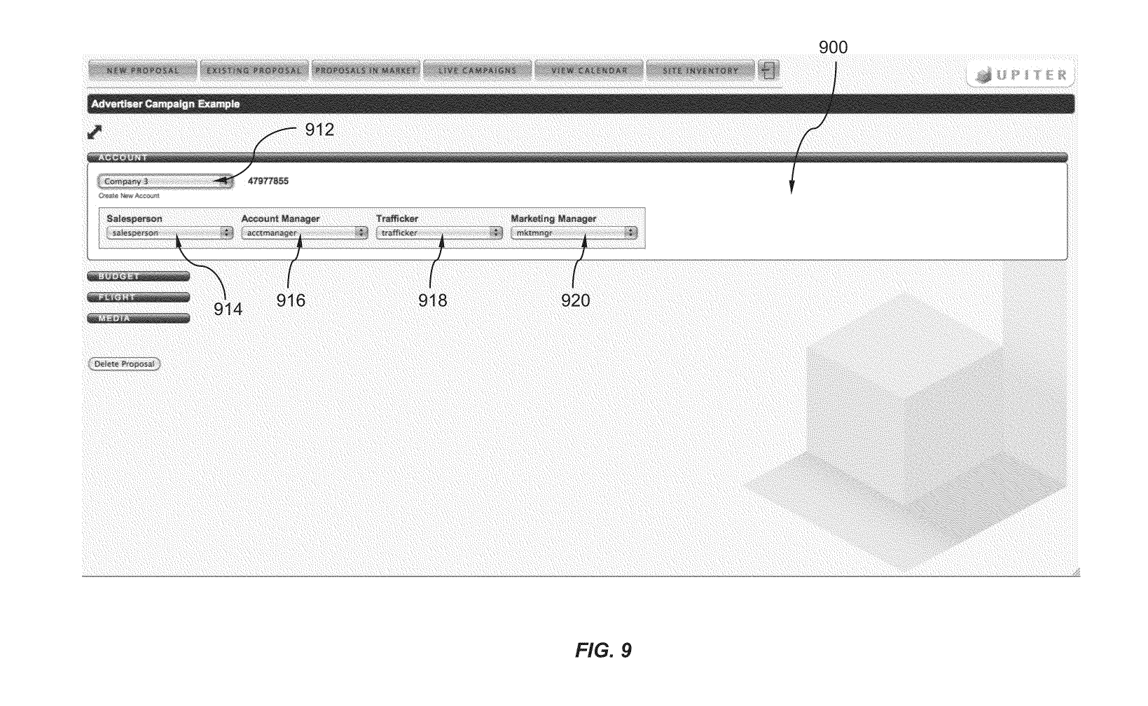

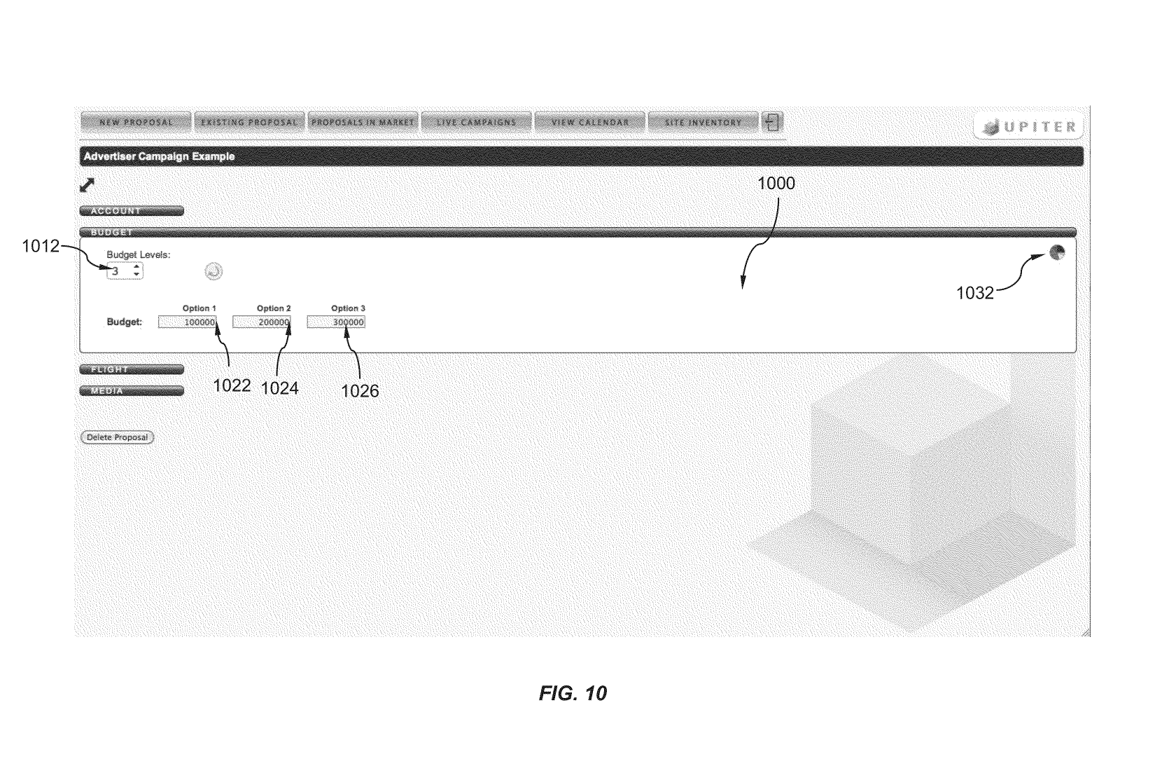

When the user selects Account button 822 of Proposal window 800, an Account window 900 opens as shown in FIG. 9. Account window 900 allows the user to enter into the system information about an account for the new proposal. Account window 900 includes data fields 912, 914, 916, 918 and 920 that allow a user to enter a Company name for the account, a salesperson for the account, an account manager for the account, a trafficker for the account and a marketing manager for the account, respectively. If the new proposal is for an existing advertiser, the personnel associated to the account will automatically populate the applicable fields of Account window 900.

When the user selects Budget button 824 of Proposal window 800, a Budget window 1000 opens as shown in FIG. 10. In budget window 1000 the user has chosen the number “3” for the number of budget levels in data field 1012, thereby by causing data fields 1022, 1024 and 1026 to appear allowing a user to enter a budget for three different options, i.e., Option 1, Option 2 and Option 3. Budget window 1000 also includes a Target Group icon 1032 that may be selected by a user.

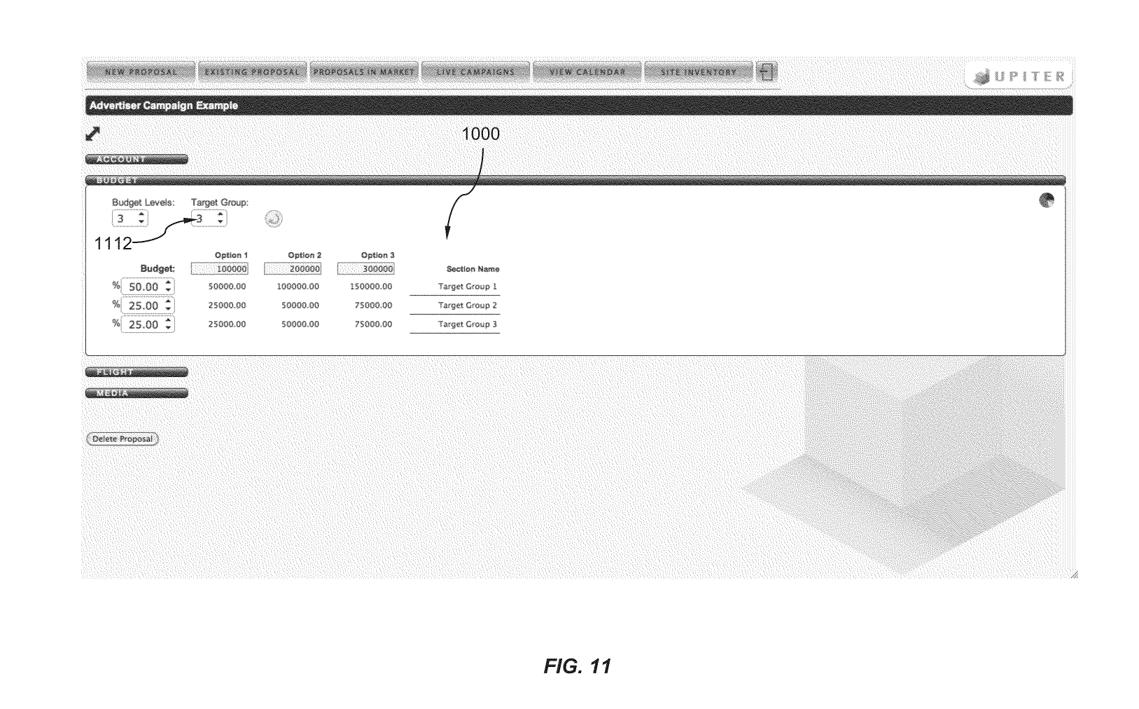

By selecting Target Group icon 1032, the user has the option to divide the budget into target groups as shown in FIG. 11. When Target Group icon 1032 is selected by the user, Target Group field 1112 appears as shown in FIG. 11. As shown in FIG. 11, the user has chosen the number “3” for the number of target groups, thereby creating Target Group 1, Target Group 2 and Target Group 3. As shown in FIG. 11, Target Group 1 has been assigned 50% of the budget, Target Group 2 has been assigned 25% of the budget and Target Group 3 has been assigned 25% of the budget. FIG. 11 shows the amount of the budget allocated to each of the three target groups for each of the three options. A scenario like this may occur if the user wants an exact allocation of the budget to different ad types. For example, 50% of the budget may be allocated to desktop “display” ads, 25% may be allocated to video ads, and 25% may be allocated to mobile device ads.

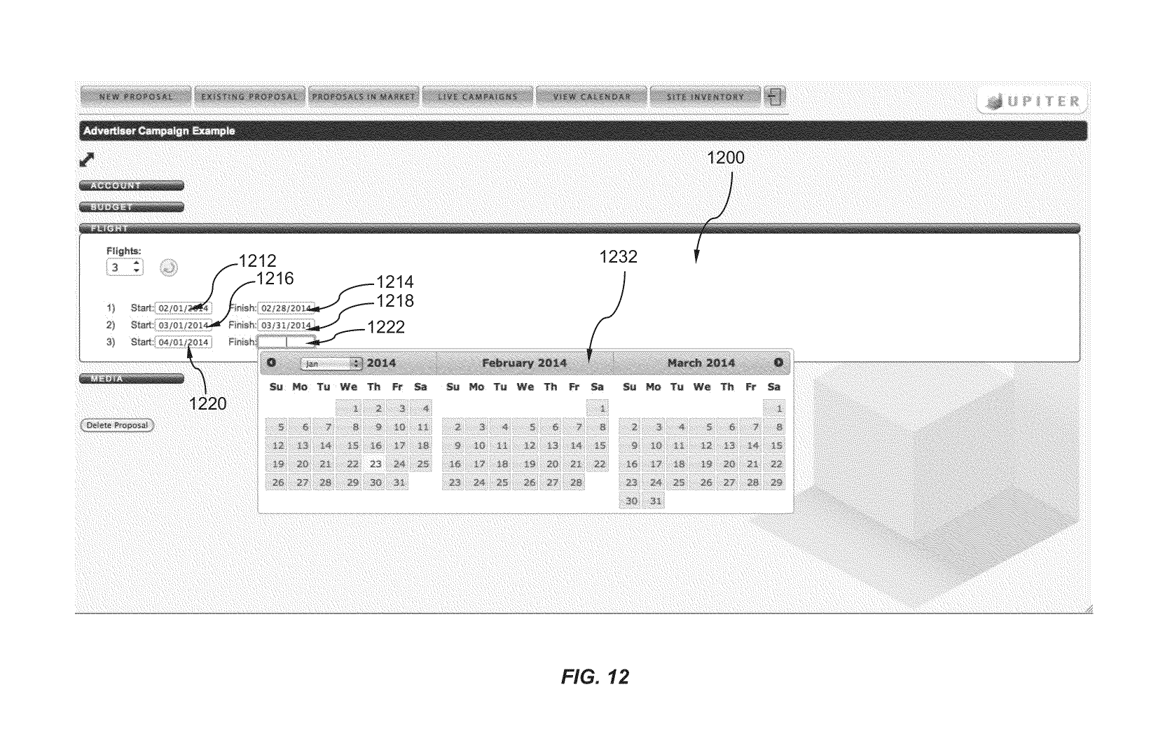

When the user selects Flight button 826 of Proposal window 800, a Flight window 1200 opens as shown in FIG. 12. As shown in FIG. 12, the user has chosen the number “3” for the number of flights thereby allowing a user to enter three sets of flight dates with each set of flight dates having a start date and finish date. The dates may be directly entered by the user in data entry boxes 1212, 1214, 1216, 1218, 1220 or 1222 or entered by selecting a date in a calendar pop-up window 1232 that appears when a user selects one of the data entry boxes. In FIG. 12, the selection of data entry box 1222 by the user causes calendar pop-up window 1232 to appear.

As shown in FIG. 12, there are often multiple flights in a campaign. Even if there is one continuous flight, advertisers may ask for monthly delivery goals to accommodate their billing cycle. Therefore a campaign may distinguish a February flight, March flight, and April flight, even if the flight runs continuously from February 1^{st} to April 30^{th}.

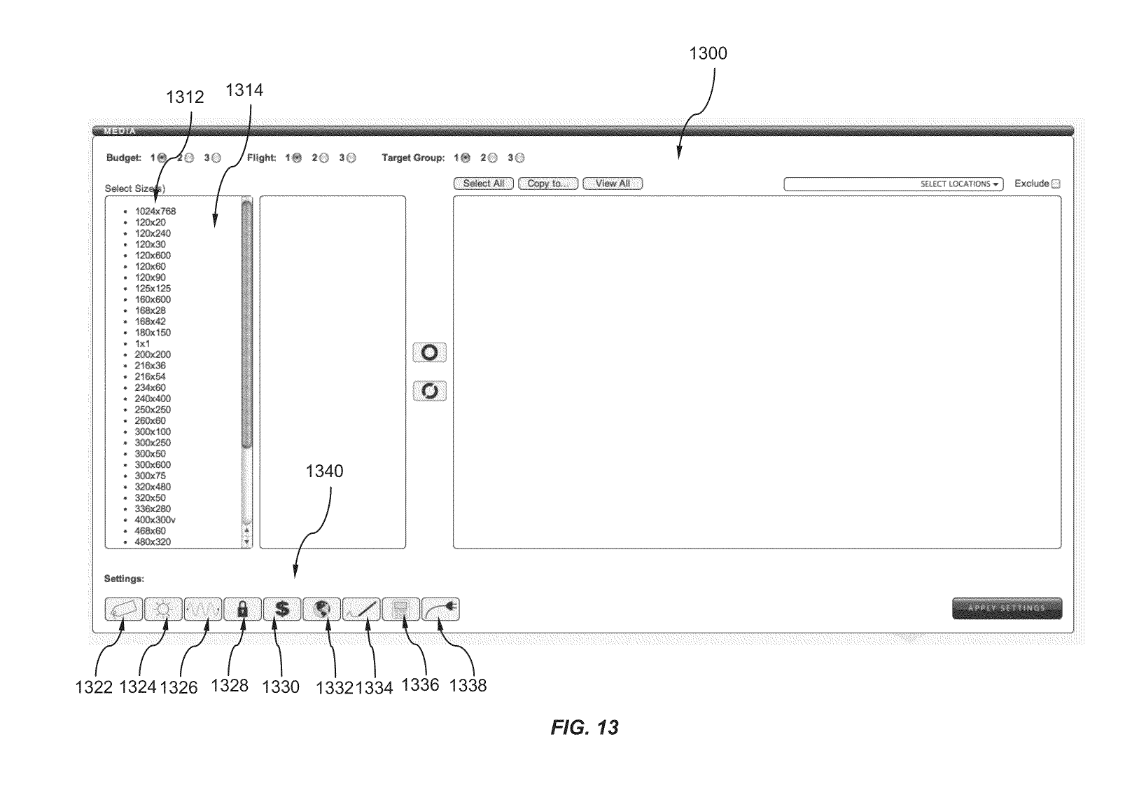

When the user selects Media button 828 of Proposal window 800, a Media window 1300 opens as shown in FIG. 13. A list of available ad sizes displays 1312 are shown in far left column 1314, which can then be selected individually or as a group. Delivery setting buttons 1322, 1324, 1326, 1328, 1330, 1332, 1334, 1336 and 1338 are displayed in a menu 1340. These setting buttons allow a user to select settings for features that are available directly in the ad server for the system. For example, a user may select: a Label by selecting setting button 1322, Day-Part Targeting by selecting setting button 1324, Frequency Capping by selecting setting button 1326, Creative Delivery Options by selecting setting button 1328, Cost Method (CPM, CPC, Flat Fee, Added Value, Offline Charge) by selecting setting button 1330, Geo-Targeting by selecting setting button 1332, Custom Criteria by selecting setting button 1334, Device Targeting by selecting setting button 1336, and Connection Targeting by selecting setting button 1338.

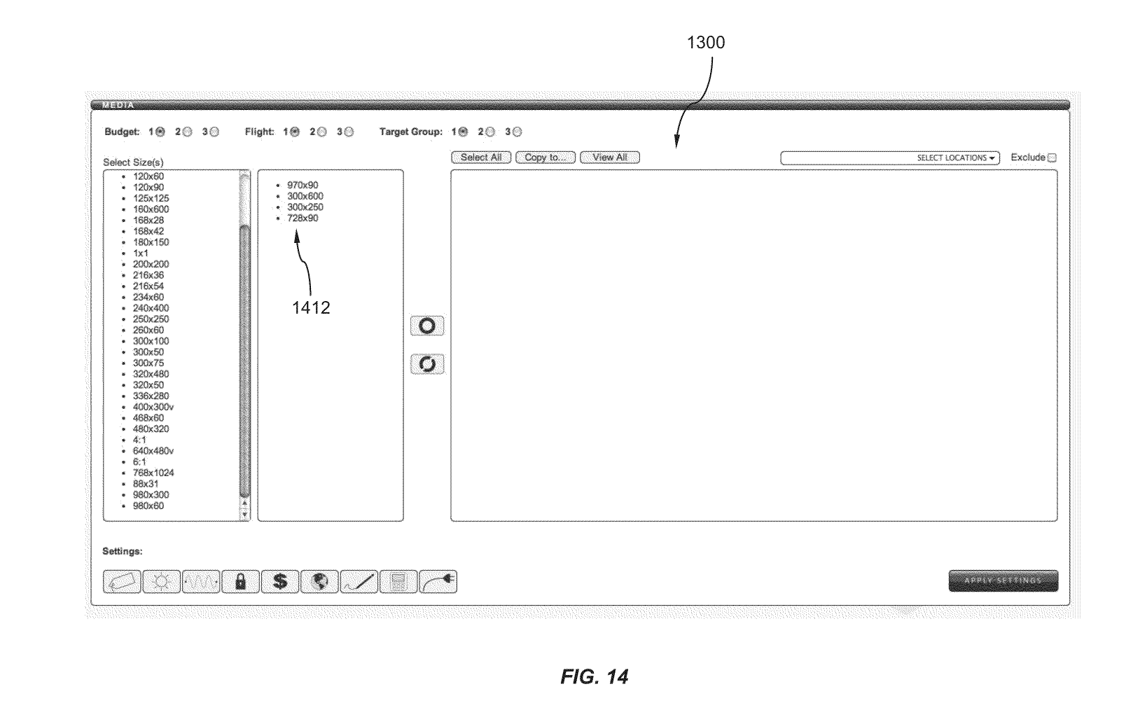

FIG. 14 shows the user selecting creative sizes 1412. FIG. 14 illustrates a “grouped” or “bundled” ad placement where multiple sizes contribute to the same delivery goal and are included on the same line item.

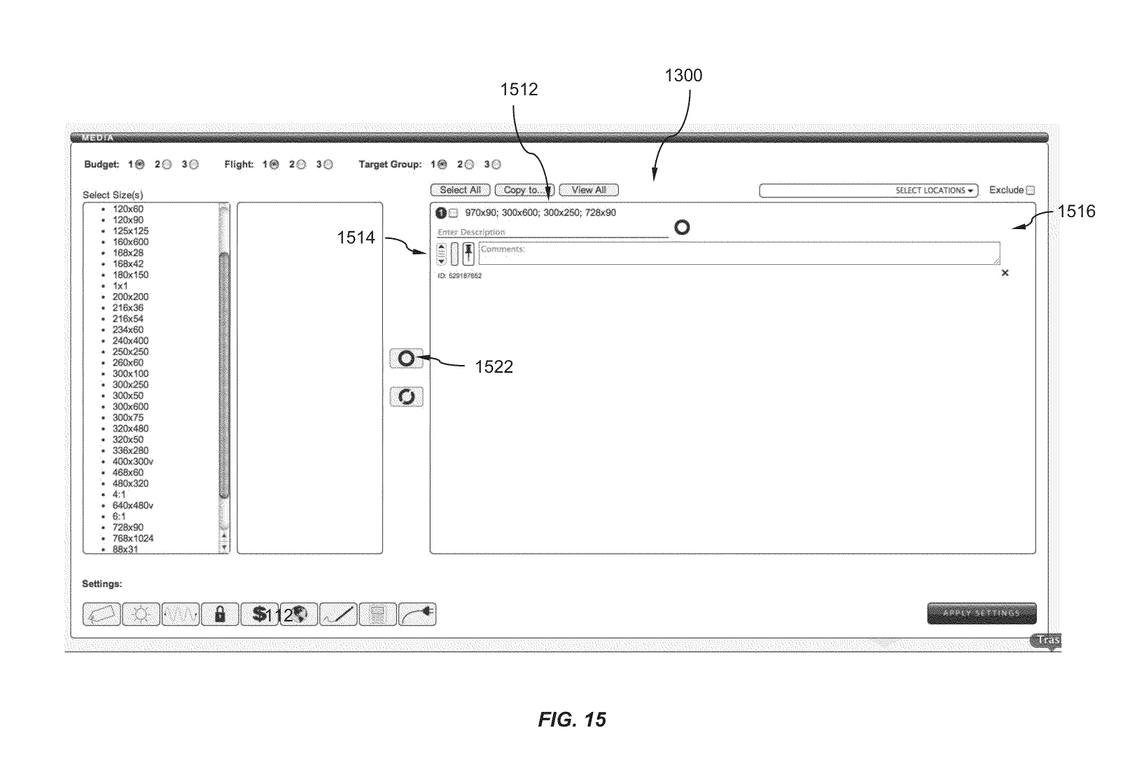

FIG. 15 show the user bringing selected sizes 1512 for an ad placement 1514 into a line item window 1516 by selecting solid ring icon 1522, which indicates a fixed ad placement. In line item window 1516, the user can add a name for the ad placement, comments for the trafficker, and apply settings and location.

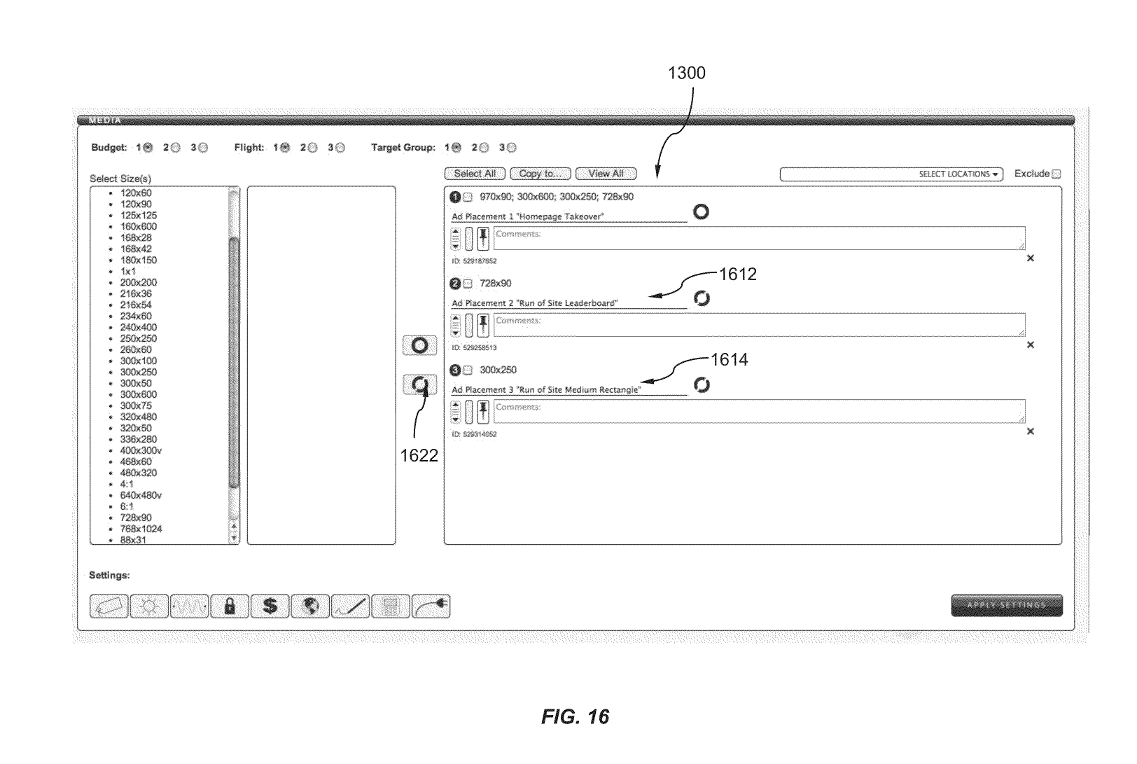

FIG. 16 shows a user adding rotational ad placements 1612 and 1614 by selecting rotational ring icon 1622.

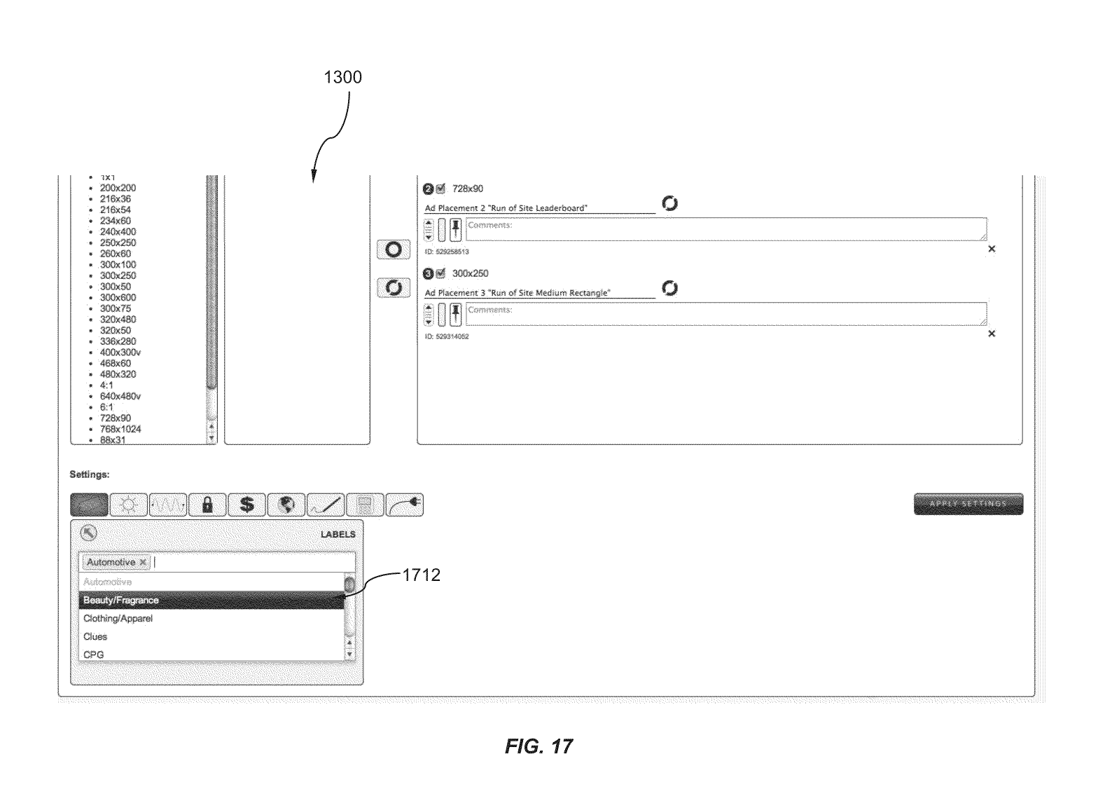

FIG. 17 shows a user applying an applicable setting, i.e. a label 1712, to ad placement 1614 by selecting setting button 1322.

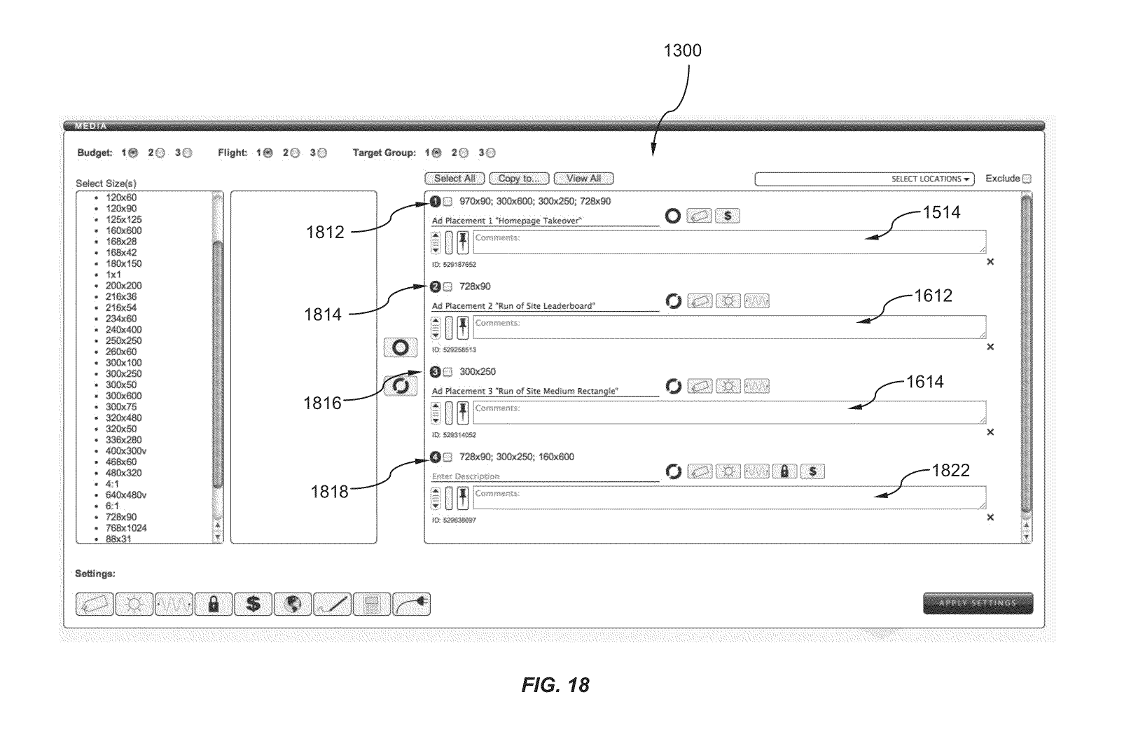

FIG. 18 shows icons 1812, 1814 and 1816 and 1818 that appear next to each respective ad placement, i.e., ad placements 1514, 1612, 1614 and 1822, to indicate a setting has been applied to each respective ad placement.

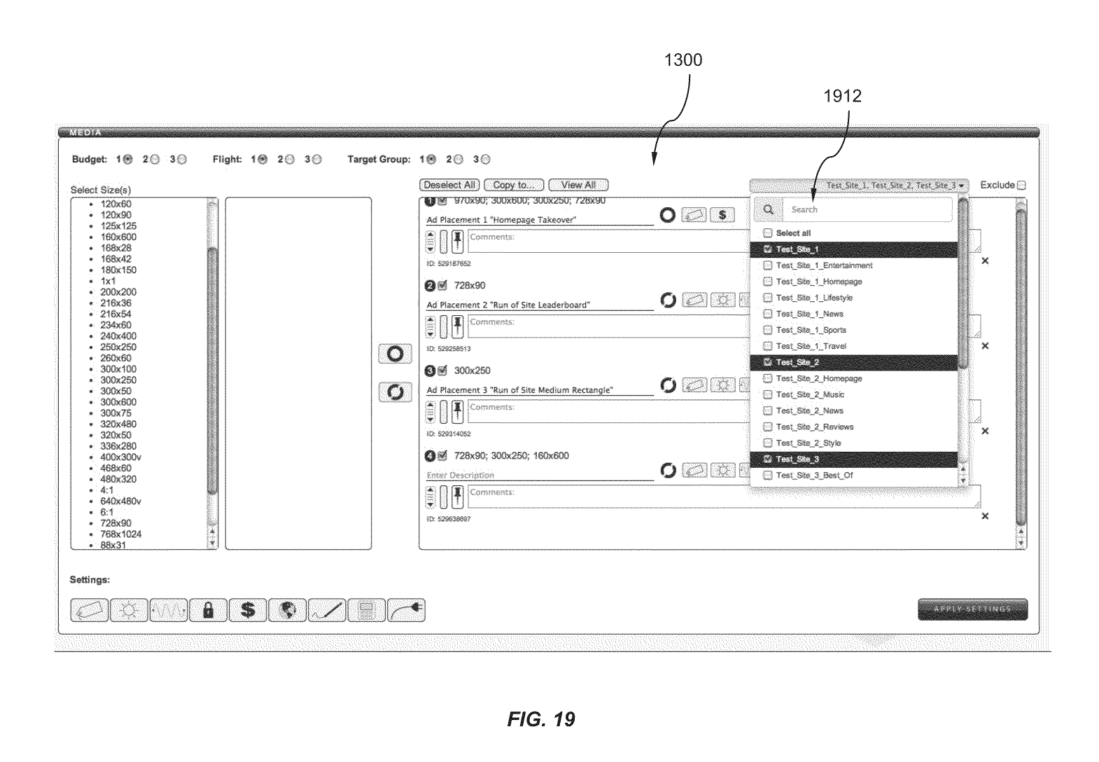

FIG. 19 shows locations 1912 assigned by the user to selected ad placements.

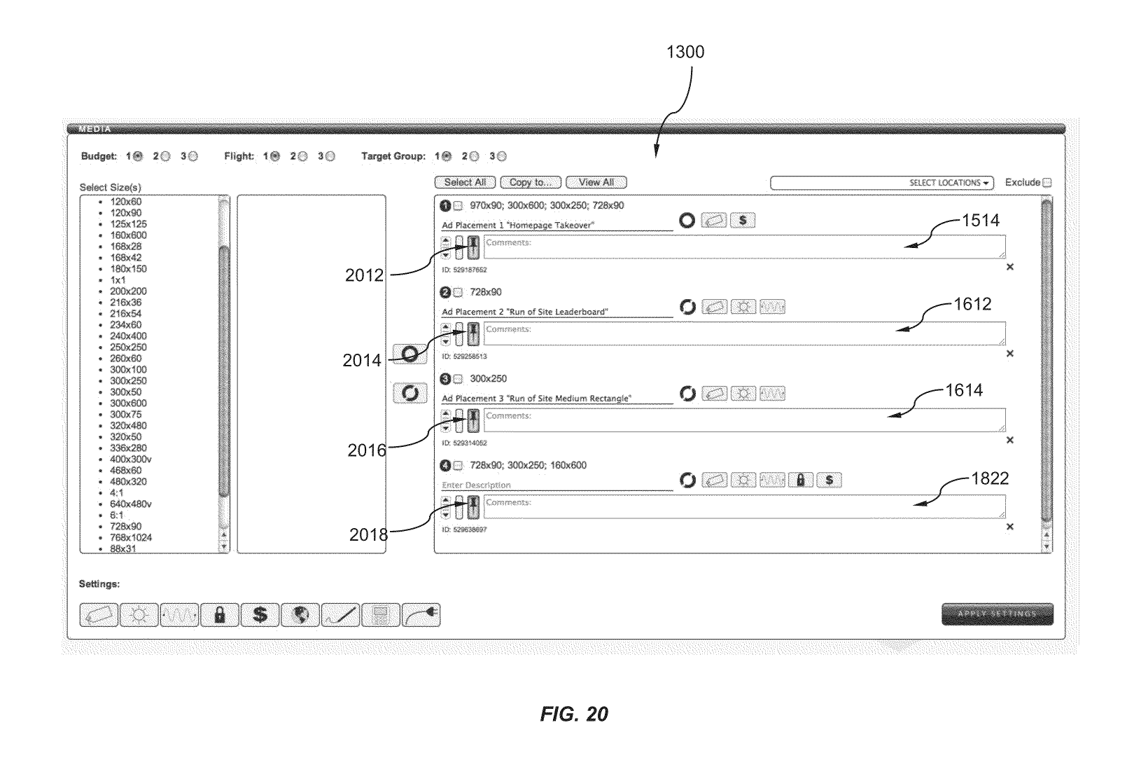

FIG. 20 shows respective pin icons 2012, 2014, 2016 and 2018 that become highlighted to indicate that a location has been applied to each respective ad placement of ad placements 1514, 1612, 1614 and 1822.

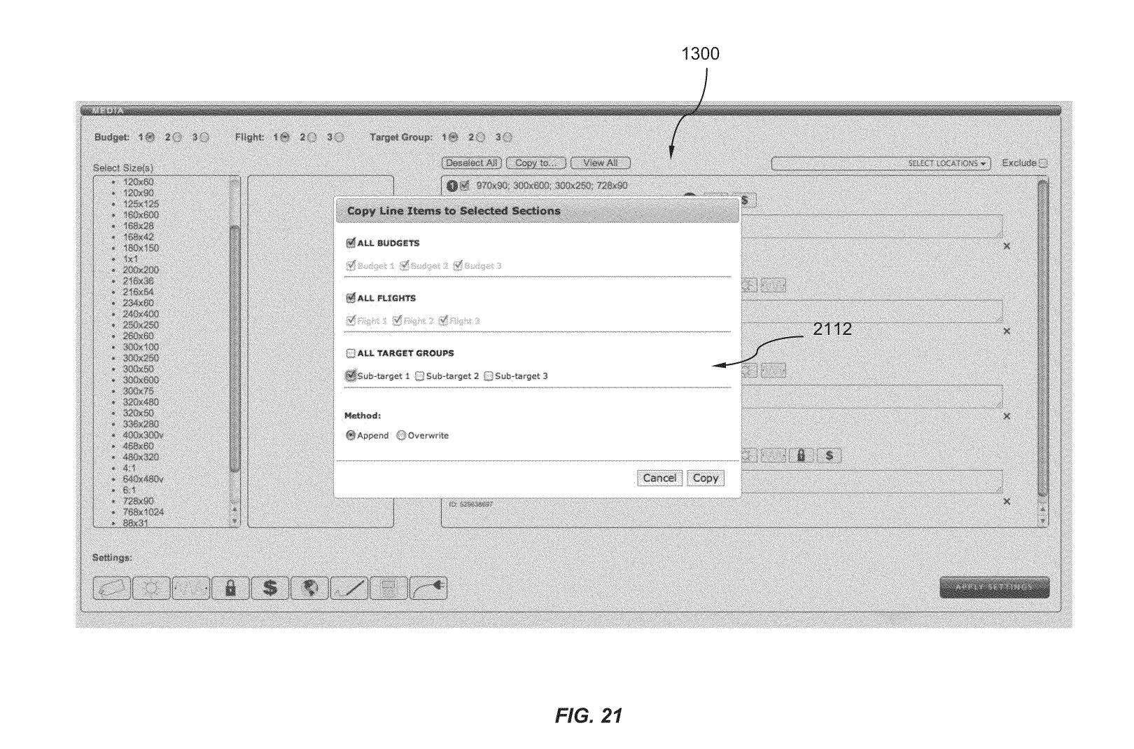

FIG. 21 shows that when all desired ad placements have been added, the user can copy the desired ad placements to other flights, budgets, and target groups as desired using pop-up window 2112.

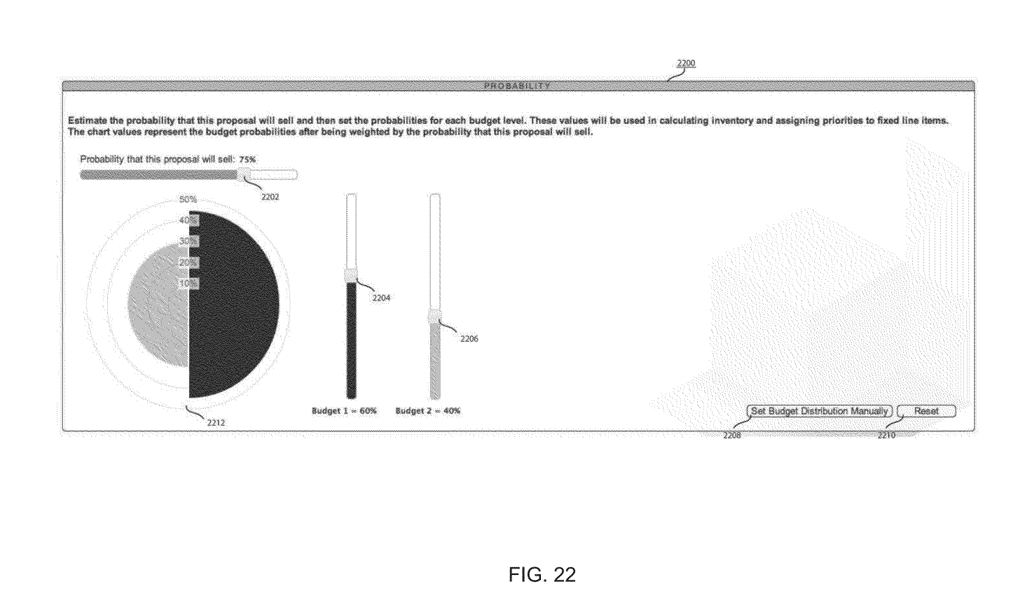

FIG. 22 shows a screenshot of a Probability window in which a user assigns the sell-through probability to the campaign and to each respective budget option. A user assigns a sell-through probability 2202 to the campaign and then weights the sell-through probability of each budget option, i.e., budget options 2204 and 2206. The user may select and drag a button to assign the probability of each budget option, or the user may set the probability of each budget option by selecting a button 2208 and entering the value. The user may reset the probability values by selecting a button 2210. A graphical representation of each budget options' sell-through probability 2212 is displayed.

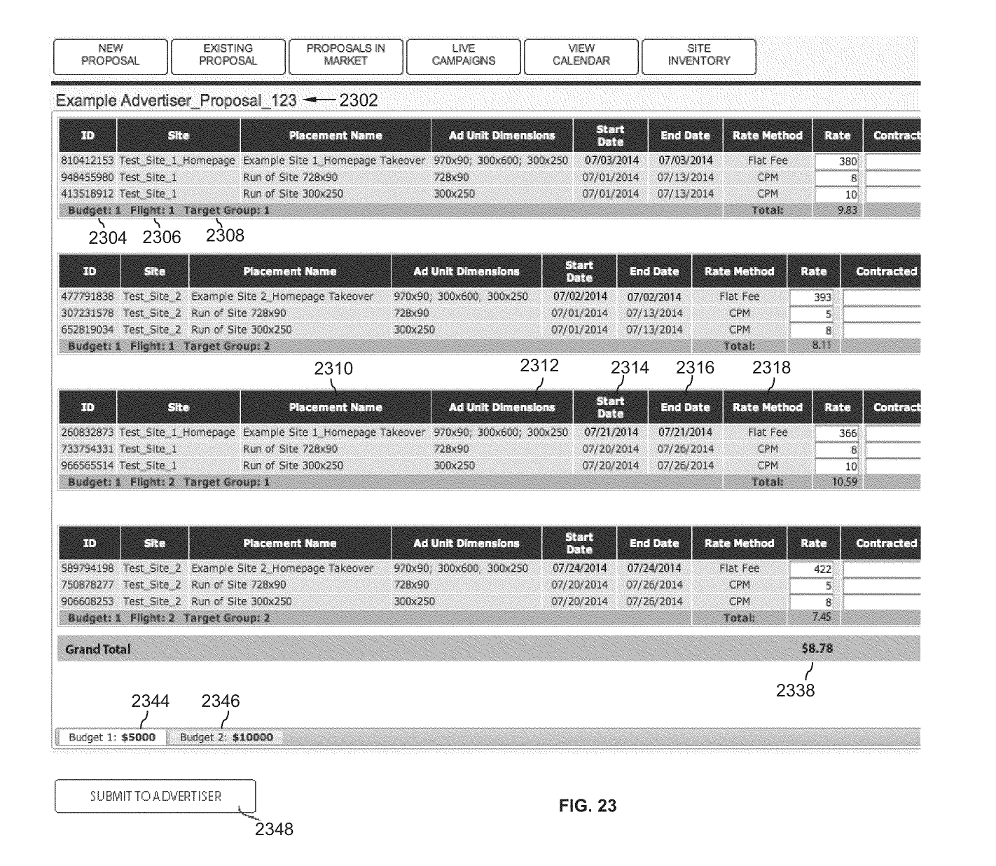

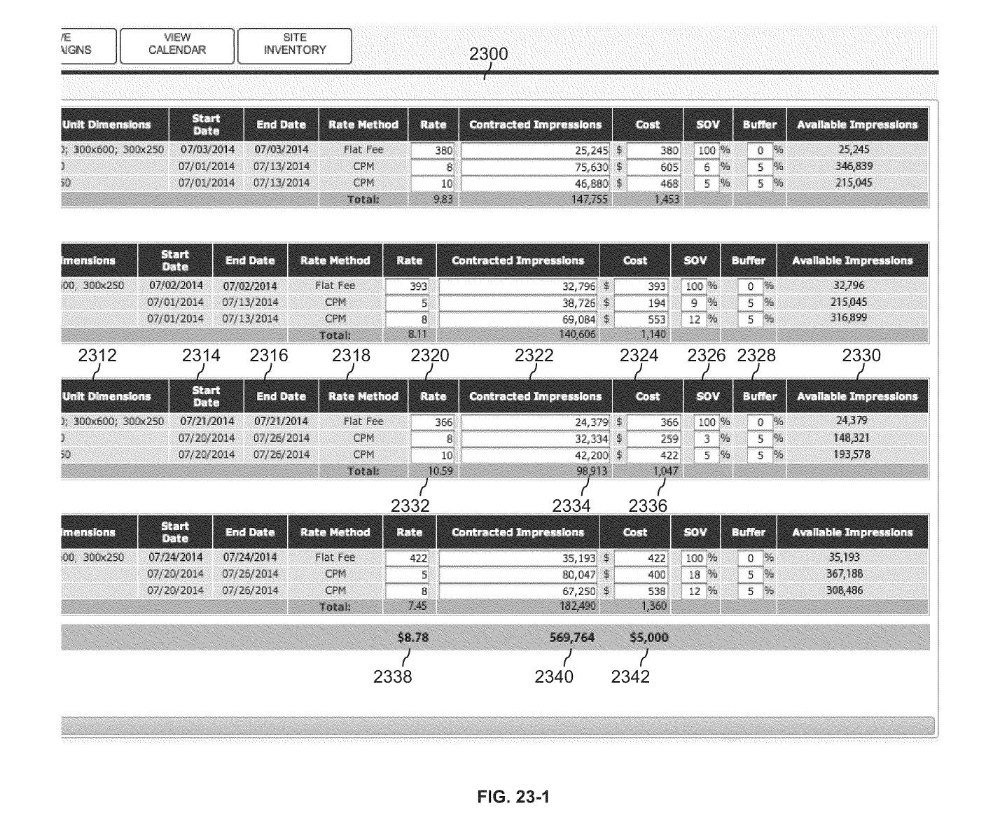

FIGS. 23 and 23-1 shows a screenshot of the final output of campaign criteria in the form of a media plan. The fields present on the media plan contain values that are pulled directly from user-input campaign criteria as well as fields that contain values that automatically filled out by the system. This media plan is generated when a user, such as a publisher, enters campaign criteria: proposal name, advertiser name, budget options, campaign flights, the type of ad units, the sell-through probability of each budget option, where those ad units will display, the target audience, target groups, day-part targeting, and frequency capping. Some criteria may be displayed on the media plan interface, while other criteria may not be displayed, and is only considered for the purpose of forecasting available inventory. The user submits these criteria by selecting a button, for example, which then prompts the system to display the media plan interface 2300. Proposal name 2302 is displayed in the top left corner of the media plan interface, which incorporates the name of the advertiser. A budget option 2304, i.e., “Budget: 1” is displayed, indicating that the ad placements displayed above budget option 2304 are included in the first budget option. A campaign flight 2306, i.e., “Flight: 1” is displayed, indicating that the ad placements displayed above campaign flight 2306 are included in the first campaign flight. A target group 2308, i.e., “Target Group: 1” is displayed, indicating that the ad placements displayed above target group 2308 are included in the first target group. The name of each ad placement is displayed in column 2310. The dimensions (measured in pixels) of each ad unit included in the ad placement are displayed in column 2312. The start date of each of the ad placements is displayed in column 2314. The end date of each of the ad placements is displayed in column 2316. A rate method of each ad placement is displayed in column 2318. A price (rate) of the delivery metric of each ad placement is displayed in column 2320. The number of impressions each ad placement is contracted to deliver, i.e., the number of contracted impressions for each ad placement, is displayed in column 2322. The total cost of each ad placement is displayed in column 2324. The total cost is based on the rate method, rate, and contracted impressions of each respective ad placement. The share of voice (SOV) of each ad placement is displayed in column 2326. The percentage of delivery metric inventory to be added to the delivery goal of each ad placement (the “buffer”) is shown in column 2328. The number of available impressions for each ad placement is displayed in column 2330. The average rate of the ad placements in column 2320 is shown in box 2332 as being $10.59. This average rate is a weighted average based on the amount of delivery metric inventory of each ad placement and the cost of each ad placement. The first ad placement in column 2320 has a “flat fee”, i.e., the rate is the full cost of the ad placement. The following two ad placements have a CPM rate of 8 and 10 respectively, which means they cost $8 and $10 for every thousand impressions served respectively. The average rate in box 2332 is calculated by taking the total cost of the applicable ad placements (1,047), dividing by the applicable impressions (98,913) and multiplying by 1000. The total number of contracted impressions in column 2322 is shown in box 2334 as being 98,913. The sum of the costs of the ad placement in column 2324 are shown in box 2336 as being $1,047. The average rate for all ad placements included in budget option 1 is shown in box 2338 as being $8.78. This average rate is a weighted average based on the amount of delivery metric inventory of each ad placement and the cost of each ad placement in budget option 1. The sum of the delivery metric inventory contracted for each ad placement included in budget option 1 is shown in box 2340 as being 569,764. The sum of the costs of each ad placement included in budget option 1 is shown in box 2342 as being $5,000. A selected tab or button 2344 labeled “Budget 1: $5,000” is displayed, indicating that media plan interface 2300 that's being displayed is displaying budget option 1. A deselected tab or button 2346 labeled “Budget 2: $10,000” is displayed, indicating that media plan interface 2300 is displaying budget option 1 and that budget option 2 is not in view. The user may select button 2346 labeled “Budget 2: $10,000” to bring budget option 2 into view. A button 2348 labeled “submit to advertiser” is displayed, which when selected, sends the media plan to the advertiser.

### Example 2

An example of the method shown in FIG. 2 will now be described. A publisher enters the following campaign criteria: advertiser name, proposal name, budget options, campaign flights, the type of ad units, where those ad units will display, the sell-through probability of each budget option, the target audience, target groups, day-part targeting, and frequency capping. In this example, the values of these criteria are as follows: Generic Clothing Brand (advertiser), Spring/Summer Initiative (proposal name), $5,000 and $10,000 (budget options), May 1-May 31 and June 1-June 30 (flight dates), rotational 300×250 and fixed 300×250 (type of ad units), Example.com and Example.com/news (where the ad units will display, i.e. the location), 25% and 40% (the sell-through probabilities of each budget option), users located in the United States and Internet Explorer Browsers (the target audience), 50% rotational ad placements and 50% fixed ad placements (target groups), Monday-Friday and 8 am-8 pm (day-part targeting), 3× per user per week (frequency capping). The user assigns different combinations of these criteria, including “rotational 300×250+Example.com” and “fixed 300×250+Example.com/news,” which comprise the ad placements on the media plan. Once this information has been entered into the system, the system pushes these criteria to the ad server as an order containing specific ad placements. The ad server then returns the available inventory of each ad placement back to the system. If there is sufficient inventory for each ad placement, the system assigns an optimal inventory allocation to each ad placement. If there is insufficient inventory available for each ad placement, the system asks the user permission to increase the rates for each ad placement. If the user allows the system to increase the rates for each ad placement, the system reserves all remaining available inventory for each ad placement and increases the rates for each ad placement until the campaign budgets are met. If the user decides the rates cannot be increased, the system then provides alternative campaign criteria, i.e. alternative ad placements that have sufficient available inventory during the campaign flights. For this example, if there is insufficient available inventory and the user does not allow the system to increase rates, the system might recommend the following: rotational 160×600, 728×90, 300×600 on Example.com. The user then enters these additional criteria, providing additional inventory to meet the campaign budgets at the current rates.

### Example 3

An example of the method shown in FIG. 3 will now be described. A publisher enters the following campaign criteria: advertiser name, proposal name, budget options, campaign flights, the type of ad units, where those ad units will display, the sell-through probability of each budget option, the target audience, target groups, day-part targeting, and frequency capping. In this example, the values of these criteria are as follows: Generic Clothing Brand (advertiser), Spring/Summer Initiative (proposal name), $5,000 and $10,000 (budget options), May 1-May 31 and June 1-June 30 (flight dates), rotational 300×250 and fixed 300×250 (type of ad units), Example.com and Example.com/news (where the ad units will display, i.e. the location), 25% and 40% (the sell-through probability of each budget option), users located in the United States and Internet Explorer browsers (the target audience), 50% rotational ad placements and 50% fixed ad placements (target groups), Monday-Friday and 8 am-8 pm (day-part targeting), 3× per user per week (frequency capping). The user assigns different combinations of these criteria, such as “rotational 300×250+Example.com” and “fixed 300×250+Example.com/news,” which comprise the ad placements on the media plan. Once this information has been entered into the system, the system pushes these criteria to the ad server as an order containing specific ad placements. The server then returns the available inventory for each ad placement to the system. Once the available inventory has been returned to the system, the system queries a database for historical information. If there is a historical rate matching “Generic Clothing Brand+rotational 300×250+Example.com” or “Generic Clothing Brand+fixed 300×250+Example.com/news” the system will assign the historical rate to the respective ad placements. However, if the system does not return a match for the present criteria, the system will query a database for a rate card price floor and a rate card price ceiling, and determine the optimal rate based on the amount of inventory available. For example, “Generic Clothing Brand+rotational 300×250+Example.com” does not return a historical rate matching that combination of criteria. The system then queries a database for the rate card price floor and rate card price ceiling for “rotational 300×250+Example.com” and identifies a rate card price floor of $10 and a rate card price ceiling of $15. The system then chooses a rate between $10 and $15 based on the amount of inventory available. If the ad server is forecasting that 50% of total inventory is available, for example, the system would choose a rate of $12.50 or possibly some value within the range of $10 and $15 that is proportionate to the inventory available for “Generic Clothing Brand+rotational 300×250+Example.com”.

### Example 4

An example of the method shown in FIG. 4 will now be described. It should be understood that fixed ad placements typically have a shorter flight date within the campaign flight, and the system will assign a flight date of one day to each fixed ad placement by default. It should also be understood that the terms “date,” “day” and “inventory” can be used interchangeably in the context of this example, given that fixed ad placements are assigned a flight date of one day and reserve all of the eligible inventory for the duration of that ad placement's flight. Therefore, a “reserved date” can refer to the inventory being reserved by a fixed or competing ad placement on that date. A reserved date may also be referred to as being “on hold.” A publisher enters the following campaign criteria: advertiser name, proposal name, budget options, campaign flights, the type of ad units, where those ad units will display, the sell-through probability of each budget option, the target audience, target groups, day-part targeting, and frequency capping. In this example, the values of these criteria are as follows: Generic Clothing Brand (advertiser), Spring/Summer Initiative (proposal name), $5,000 and $10,000 (budget options), May 1-May 31 and June 1-June 30 (flight dates), rotational 300×250 and fixed 300×250 (type of ad units), Example.com and Example.com/news (where the ad units will display, i.e. the location), 25% and 40% (the sell-through probabilities of each budget option), United States and Internet Explorer browsers (the target audience), 50% rotational ad placements and 50% fixed ad placements (target groups), Monday-Friday and 8 am-8 pm (day-part targeting), 3× per user per week (frequency capping). Once the campaign criteria have been entered and the user “submits” the campaign criteria for the purpose of creating the media plan, the system identifies any fixed ad placements. In this example, the system identifies the fixed ad placement “fixed 300×250 on Example.com/news” which would be created by the user, i.e. the user selects the ad unit “fixed 300×250” and assigns this ad unit to the location “Example.com/news”. The system then queries a database for active proposals also containing “fixed 300×250” assigned to “Example.com/news” during the time periods May 1-May 31 and June 1-June 30. If there is an available date during these time periods, the system will assign the first day available by default. For example, the first available day during the first flight is May 7, and the first available day during the second flight is June 3. The system assigns these dates to the fixed ad placement “Generic Clothing Brand+fixed 300×250+Example.com/news.” However, if every day during the campaign flight is already reserved by a competing ad placement, the system queries a database to determine if the competing ad placements are sold. If the competing ad placements are sold, the dates being reserved by those competing ad placements are ineligible to be reserved by Generic Clothing Brand. If every date during the campaign flight is sold and there are no eligible dates to be reserved, the system recommends alternative criteria, such as “fixed 300×250+Example.com/entertainment.” If the user accepts that recommendation as alternative criteria, the user enters the new criteria into the system and the process starts over. However, if there are reserved dates during the campaign flight that are not sold, and no other dates are available, the system asks the user for permission to reserve a date that's already been reserved by a competing ad placement, i.e. a date that's on hold. If the user does not allow the system to reserve a date that's on hold, the system recommends alternative criteria as explained in the previous scenario. However, if the user does allow the system to reserve a date that's on hold, the system chooses the date being reserved by the competing ad placement with the lowest sell-through probability. For example, the ad placement “fixed 300×250+Example.com/news” has been reserved by other advertisers on all dates from May 1-May 31 and June 1-June 30, and all of those competing ad placements have sold except for those reserving inventory on May 21, May 25, June 15, and June 23. The competing ad placement on May 21 has a 10% sell-through probability, the competing ad placement on May 25 has a 90% sell-through probability, the competing ad placement on Juen 15 has a 50% sell-through probability, and the competing ad placement on June 23 has a 50% sell-through probability. In this scenario, the system will reserve the date that's reserved by the competing ad placement with the lowest sell-through probability for each flight, and the system will pick the first day if two or more competing ad placements with an equal sell-through probability are being considered. In this example, the system chooses to reserve the inventory on May 21 and June 15 because the competing ad placement on May 21 has a 10% sell-through probability while the competing ad placement on May 25 has a 90% sell-through probability. In the next flight, the system chooses June 15 because it's the first day, even though the competing ad placement on June 23 has an equal sell-through probability of 50%. Consider the same example with different sell-through probabilities for each competing ad placement, where the competing ad placements on May 21, May 25, June 15, and June 23 have the sell-through probabilities 10%, 50%, 75%, and 90% respectively. The system chooses to reserve inventory on May 21 and June 15 because the system isolates the competing ad placements of each flight when considering the reservation. Even though the competing ad placement on May 25 has a lower sell-through probability than that of the competing ad placement on June 15, the system first considers the available inventory in the first flight, and then makes a separate consideration for the inventory reservation of the second flight. The system may also warn the user when inventory is being reserved for a date that's on hold. This warning can display the sell-through probability of the competing ad placement, informing the user of the risk that the inventory won't be available. This information can help the user decide whether to reserve the inventory of a competing ad placement, or consider alternative criteria.

### Example 5

An example of the method shown in FIG. 5 will now be described. A user, such as a publisher, enters the following campaign criteria: advertiser name, proposal name, budget options, campaign flights, the type of ad units, where those ad units will display, the sell-through probability of each budget option, the target audience, target groups, day-part targeting, and frequency capping. In this example, the values of these criteria are as follows: Generic Clothing Brand (advertiser), Spring/Summer Initiative (proposal name), $5,000 and $10,000 (budget options), May 1-May 31 and June 1-June 30 (flight dates), rotational 300×250 and fixed 300×250 (type of ad units), Example.com and Example.com/news (where the ad units will display, i.e. the location), 25% and 40% (the sell-through probabilities of each budget option), United States and Internet Explorer browsers (the target audience), 50% rotational ad placements and 50% fixed ad placements (target groups), Monday-Friday and 8 am-8 pm (day-part targeting), 3× per user per week (frequency capping). The user assigns a sell-through probability to each budget option: 40% for the $5,000 option and 25% for the $10,000 option. It should be understood that the sell-through probability of the budget option is passed down to the ad placements within that budget option. So, for example, if the ad placement “rotational 300×250 on Example.com” is part of budget option 1 ($5,000), then the ad placement “rotational 300×250 on Example.com” also has a 40% sell-through probability. The user “submits” the campaign criteria for the purpose of creating a media plan, and the media plan is created by the system as explained in previous examples. Once the media plan is created, the system considers the sell-through probability of each budget option to determine the adjusted inventory reservation. It would be illogical to reserve the inventory for both budget options because the advertiser will only pick one option if any option is picked at all. Even if there were only one budget option, it may still be in the user's best interest to partially reserve this inventory, i.e. reserve a fraction of the total proposed inventory, thereby making more inventory available to other advertisers who may be more likely to buy that inventory later. In this example, the system proposes 50,000 impressions at the $5,000 budget option and 100,000 impressions at the $10,000 budget option. However, the system does not reserve all 50,000 impressions, nor 100,000 impressions, nor the combined proposed impressions of 150,000. Instead, the system considers that there's a 40% probability that 50,000 impressions will be sold, or there's a 25% probability that 100,000 impressions will be sold. The system determines an adjusted inventory reservation value of 45,000 impressions by determining the probability that some amount of inventory will be sold. It should be understood that these numbers are just used by way of example, and the adjusted inventory reservation can have a multitude of different applications for determining the amount of reserved inventory. Once the adjusted inventory reservation is determined, the system pushes the adjusted inventory reservation to the ad server where it is stored in a database, and is available to the user through a graphical user interface.

### Example 6

An example of the method shown in FIG. 6 will now be described. Within administrative settings displayed through a graphical user interface, a user administrator, such as a publisher administrator, defines a fixed placement minimum of 25%. A user, such as a publisher, enters the following campaign criteria for the purpose of creating a media plan: advertiser name, proposal name, budget options, campaign flights, the type of ad units, the sell-through probability of each budget option, where those ad units will display, the target audience, target groups, day-part targeting, and frequency capping. In this example, the values of these criteria are as follows: Generic Clothing Brand (advertiser), Spring/Summer Initiative (proposal name), $5,000 and $10,000 (budget options), May 1-May 31 and June 1-June 30 (flight dates), rotational 300×250 and fixed 300×250 (type of ad units), Example.com and Example.com/news (where the ad units will display, i.e. the location), 25% and 40% (the sell-through probabilities of each budget option) users located in the United States and users of Internet Explorer browsers (the target audience), 50% rotational ad placements and 50% fixed ad placements (target groups), Monday-Friday and 8 am-8 pm (day-part targeting), 3× per user per week (frequency capping). The user assigns the ad unit “rotational 300×250” to the location “Example.com” to create ad placement “Example.com rotational 300×250” and the user assigns the ad unit “fixed 300×250” to “Example.com/news” to create the ad placement “Example.com/news fixed 300×250.” The user also assigns the ad placement “Example.com rotational 300×250” to target group 1 (50% rotational) and assigns the ad placement “Example.com/news fixed 300×250” to target group 2 (50% fixed). The user submits these criteria, which are then pushed to an ad server, which retrieves the available inventory for each ad placement, which determines the cost of each ad placement as described in previous figures. Through the aforementioned process, the system determines that the cost of the fixed ad placement “Example.com/news fixed 300×250” is $1,000. The system then determines if “Example.com/news fixed 300×250” is part of a target group that also contains the rotational ad placement “Example.com rotational 300×250.” After determining that “Example.com/news fixed 300×250” is an isolated ad placement within target group 1, the system replicates “Example.com/news fixed 300×250” until the target group budget is met. At the $5,000 budget option, target group 1 (50% fixed) has a target group budget of $2,500. At this budget level, the system replicates “Example.com/news fixed 300×250” two times, resulting in three different ad placements: “Example.com/news fixed 300×250 (1.1),” “Example.com/news fixed 300×250 (1.2),” and “Example.com/news fixed 300×250 (1.3)” for a total cost of $3,000. It should be understood that while the target group budget is $2,500, the sum of the fixed ad placement's cost may exceed the target group budget if the target group budget is not evenly divisible by the cost of each individual fixed ad placement. At the $10,000 budget option, however, the system executes the same process, but replicates “Example.com/news fixed 300×250” four times, resulting in five different ad placements: “Example.com/news fixed 300×250 (2.1),” “Example.com/news fixed 300×250 (2.2),” “Example.com/news fixed 300×250 (2.3),” “Example.com/news fixed 300×250 (2.4),” and “Example.com/news fixed 300×250 (2.5)” for a total cost of $5,000. At the $10,000 budget option, the sum of the costs of each fixed ad placement is exactly the amount of the target group budget because the target group budget is evenly divisible by the cost of each fixed ad placement within that target group.

Consider a different scenario where the user enters the same campaign criteria with the exception of the ad placements and the target groups. In this scenario, the user creates the target groups “50% Example.com” and “50% Example.com/news.” The user then assigns the ad units “rotational 300×250” and “fixed 300×250” to both “Example.com” and “Example.com/news,” resulting in the ad placements “Example.com fixed 300×250,” “Example.com rotational 300×250,” “Example.com/news fixed 300×250,” and “Example.com/news rotational 300×250.” The user submits these criteria, which are then pushed to an ad server, which retrieves the available inventory for each ad placement, which determines the cost of each ad placement as described in previous figures. Through the aforementioned process, the system determines that the cost of the fixed ad placement “Example.com/news fixed 300×250” is $500, and the cost of ad placement “Example.com fixed 300×250” is $1,000. The system then determines if each target group contains a mix of rotational and fixed ad placements. The system recognizes that target group 1 (50% Example.com) does contain a mix of rotational and fixed ad placements: “Example.com fixed 300×250” and “Example.com rotational 300×250.” And by the same method, the system determines that target group 2 (50% Example.com/news) also contains a mix of rotational and fixed ad placements: “Example.com/news fixed 300×250” and “Example.com/news rotational 300×250.” At the $5,000 budget option, the system recognizes that within target group 1 (50% Example.com), the cost of the fixed ad placement “Example.com fixed 300×250” does meet the 25% fixed placement minimum of $625, and therefore the system does not replicate “Example.com fixed 300×250.” The remaining target group budget of $1,500 is allocated to the rotational ad placement within target group 1, “Example.com rotational 300×250.” At the same budget option, the system recognizes that within target group 2 (50% Example.com/news), the fixed ad placement “Example.com/news fixed 300×250” does not meet the fixed placement minimum of $625, and therefore the system replicates “Example.com/news fixed 300×250.” This replication results in two fixed ad placements within target group 2: “Example.com/news fixed 300×250 (1.1)” and “Example.com/news fixed 300×250 (1.2)” for a combined cost of $1,000. After replicating the fixed line items to meet the fixed placement minimum, the system then allocates the remaining target group budget of $1,500 to the rotational ad placement “Example.com/news rotational 300×250.”

At the $10,000 budget option, the same method would apply. The system recognizes that within target group 1 (50% Example.com), the cost of the fixed ad placement “Example.com fixed 300×250” does meet the 25% fixed placement minimum of $1,000, and therefore the system does not replicate “Example.com fixed 300×250.” The remaining target group budget of $4,000 is allocated to the rotational ad placement within target group 1, “Example.com rotational 300×250.” At the same budget option, the system recognizes that within target group 2 (50% Example.com/news), the fixed ad placement “Example.com/news fixed 300×250” does not meet the fixed placement minimum, and therefore the system replicates “Example.com/news fixed 300×250.” This replication results in two fixed ad placements within target group 2: “Example.com/news fixed 300×250 (2.1)” and “Example.com/news fixed 300×250 (2.2)” for a combined cost of $1,000. The system then allocates the remaining target group budget of $4,000 to the rotational ad placement “Example.com/news rotational 300×250.”

All documents, patents, journal articles and other materials cited in the present application are incorporated herein by reference.

While the present invention has been disclosed with references to certain embodiments, numerous modification, alterations, and changes to the described embodiments are possible without departing from the sphere and scope of the present invention, as defined in the appended claims. Accordingly, it is intended that the present invention not be limited to the described embodiments, but that it has the full scope defined by the language of the following claims, and equivalents thereof.

What is claimed is:

1. An apparatus comprising:
one or more processors, and
a machine-readable medium for storing instructions thereon which when executed by the one or more processors cause the one or more processors to perform a method comprising the following steps:
(a) assigning an optimal inventory allocation to each ad placement of one or more proposed ad placements, and
(b) displaying the optimal inventory allocation of each ad placement on a visual display device to a user and/or saving the optimal inventory allocation of each ad placement to a storage medium,
wherein the optimal inventory allocation of each ad placement is based on an available inventory for the ad placement, and
wherein the inventory is a delivery metric inventory.

2. The apparatus of claim 1, wherein the method comprises the following step that is conducted prior to step (a):
(c) determining the available inventory for each ad placement of the one or more ad placements.

3. The apparatus of claim 1, wherein the method comprises the following step:
(c) increasing a rate for each ad placement until a campaign budget is met and all available inventory is allocated to each ad placement,
wherein each rate is increased proportionally across all of the one or more ad placements.

4. An apparatus comprising:
one or more processors, and
a machine-readable medium for storing instructions thereon which when executed by the one or more processors cause the one or more processors to perform a method comprising the following steps:
(a) assigning an optimal rate to one or more ad placements, and
(b) displaying the optimal rate on a visual display device to a user and/or saving the optimal rate to a storage medium,
wherein the optimal rate is based on an available inventory for the ad placement, a rate card price floor for the ad placement, a rate card price ceiling for the ad placement and a historical rate for the ad placement.

5. The apparatus of claim 4, wherein the method comprises the following step that is conducted prior to step (a):
(c) determining available inventory for the ad placement.

6. The apparatus of claim 4, wherein the method comprises the following step that is conducted prior to step (a):
(c) determining the rate card price floor for the ad placement.

7. The apparatus of claim 4, wherein the method comprises the following step that is conducted prior to step (a):
(c) determining the rate card price ceiling for the ad placement.

8. The apparatus of claim 4, wherein the method comprises the following step that is conducted prior to step (a):
(c) determining the historical rate for the ad placement.

9. An apparatus comprising:
one or more processors, and
a machine-readable medium for storing instructions thereon which when executed by the one or more processors cause the one or more processors to perform a method comprising the following steps:
(a) assigning one or more flight dates to one or more respective fixed ad placements, and
(b) displaying the one or more flight dates on a visual display device to a user and/or saving the one or more flight dates to a storage medium,
wherein each of the one or more flight dates is assigned to a respective fixed ad placement based on an availability of dates within a campaign flight.

10. The apparatus of claim 9, wherein the method comprises the following step that is conducted prior to step (a):
(c) determining the availability of dates within the campaign flight.

11. An apparatus comprising:
one or more processors, and
a machine-readable medium for storing instructions thereon which when executed by the one or more processors cause the one or more processors to perform a method comprising the following steps:
(a) sending an adjusted inventory reservation to an ad server, and
(b) displaying the adjusted inventory reservation on a visual display device to a user and/or saving the adjusted inventory reservation to a storage medium,
wherein the adjusted inventory reservation is based on a sell-through probability for an ad placement and a delivery goal for the ad placement.

12. The apparatus of claim 11, wherein the method comprises the following step that is conducted prior to step (a):
(c) determining the sell-through probability for the ad placement.

13. The apparatus of claim 11, wherein the method comprises the following step that is conducted prior to step (a):
(c) determining the delivery goal for the ad placement.

14. An apparatus comprising:
one or more processors, and
a machine-readable medium for storing instructions thereon which when executed by the one or more processors cause the one or more processors to perform a method comprising the following steps:
(a) replicating fixed ad placements until a fixed placement minimum is met, and
(b) displaying the replicated fixed ad placements on a visual display device to a user and/or saving the replicated fixed ad placements to a storage medium,
wherein the fixed placement minimum is based on a cost of fixed ad placements in a target group.

15. The apparatus of claim 14, wherein the method comprises the following step that is conducted prior to step (a):
(c) setting a fixed placement minimum.

16. The apparatus of claim 14, wherein the method comprises the following step that is conducted prior to step (a):
(c) determining the cost of fixed ad placements in the target group.
